(19) United States
(12) Patent Application Publication
(10) Pub. No.: US 2025/0275008 A1
(43) Pub. Date: Aug. 28, 2025

(54) METHOD OF TRANSMITTING OR RECEIVING CONTROL-PLANE MESSAGE THROUGH FRONTHAUL INTERFACE AND ELECTRONIC DEVICE PERFORMING THE METHOD

(71) Applicant: SAMSUNG ELECTRONICS CO., LTD., Suwon-si (KR)

(72) Inventors: Jongho OH, Suwon-si (KR); Wonjun HWANG, Suwon-si (KR); Hyeri BANG, Suwon-si (KR); Woonsang LEE, Suwon-si (KR); Hyoungjin LIM, Suwon-si (KR)

(73) Assignee: SAMSUNG ELECTRONICS CO., LTD., Suwon-si (KR)

(21) Appl. No.: 19/208,025

(22) Filed: May 14, 2025

Related U.S. Application Data
(63) Continuation of application No. PCT/KR2024/096952, filed on Dec. 13, 2024.

(30) Foreign Application Priority Data
Dec. 14, 2023 (KR) 10-2023-0182375
Nov. 27, 2024 (KR) 10-2024-0172749

(51) Int. Cl. H04W 76/20; H04L 25/02; H04W 92/12

(52) U.S. Cl. CPC H04W 76/20; H04L 25/0204; H04W 92/12

(57) ABSTRACT

A method for wireless communication performed by a distributed unit (DU) includes receiving, from a radio unit (RU), a management-plane message including information about a control-plane message supported by the RU, generating, based on the management-plane message, a first control-plane message including a field indicating a first user equipment identifier (UE ID) and a first section extension field, and transmitting, to the RU through a fronthaul interface, the first control-plane message during a time period longer than a slot. The first section extension field includes a parameter indicating a number of UE IDs of a user associated with the first UE ID.

### CROSS-REFERENCE TO RELATED APPLICATIONS

This application is a continuation application of International Application No. PCT/KR2024/096952, filed on Dec. 13, 2024, which claims priority to Korean Patent Application No. 10-2023-0182375, filed on Dec. 14, 2023, and Korean Patent Application No. 10-2024-0172749, filed on Nov. 27, 2024, in the Korean Intellectual Property Office, the disclosures of which are incorporated by reference herein in their entireties

### BACKGROUND

### 1. Field

The present disclosure relates to wireless communication based on a fronthaul interface, and more particularly, to a method of transmitting or receiving a control-plane message through a fronthaul interface and an electronic device performing the method.

### 2. Description of Related Art

In the related art, as for a base station providing a wireless communication service, a data processing unit or digital unit (or distributed unit (DU)) and a wireless transceiver unit or radio unit (or remote unit (RU)) of the base station are integrally installed together in a cell site. Due to increases in numbers of users and/or amount of traffic, a base station may not be suitable for establishing a plurality of cell sites. In an attempt to overcome such a limitation, a base station may have been developed to have a structure in which a DU is concentratively arranged in one physical location and only an RU may be left in a cell site that may exchange wireless signals with a terminal. For example, the DU and the RU may be connected to each other by an optical cable, a coaxial cable, or the like. Such a base station structure is also being standardized in the 3rd Generation Partnership Project (3GPP), and an open radio access network (O-RAN) as an open network standard applicable to a fifth generation (5G) wireless communication system, may be being researched.

A base station based on the O-RAN may include an O-DU and an O-RU. The O-DU and the O-RU may communicate with each other through a fronthaul interface. A fronthaul interface, according to the O-RAN standard, may be referred to as an open fronthaul interface. The fronthaul interface may include a control user synchronization (CUS) plane and a management (M) plane.

### SUMMARY

According to an aspect of the present disclosure, a method for wireless communication performed by a distributed unit (DU) includes receiving, from a radio unit (RU), a management-plane message including information about a control-plane message supported by the RU, generating, based on the management-plane message, a first control-plane message including a field indicating a first user equipment identifier (UE ID) and a first section extension field, and transmitting, to the RU through a fronthaul interface, the first control-plane message during a time period longer than a slot. The first section extension field includes a parameter indicating a number of UE IDs of a user associated with the first UE ID.

According to an aspect of the present disclosure, a method for wireless communication performed by a radio unit (RU) includes transmitting, to a distributed unit (DU), a management-plane message including information about a control-plane message supported by the RU, and receiving, from the DU through a fronthaul interface, a first control-plane message during a time period longer than a slot. The first control-plane message includes a field indicating a first user equipment identifier (UE ID) and a first section extension field. The first section extension field includes a parameter indicating a number of UE IDs of a user associated with the first UE ID.

According to an aspect of the present disclosure, a distributed unit (DU) device for wireless communication includes one or more processors including processing circuitry, and a memory storing instructions. The instructions, when executed by the one or more processors individually or collectively, cause the DU device to receive, from a radio unit (RU), a management-plane message including information about a control-plane message supported by the RU, generate, based on the management-plane message, a first control-plane message including a field indicating a first user equipment identifier (UE ID) and a first section extension field, and transmit, to the RU through a fronthaul interface, the first control-plane message during a time period longer than a slot. The first section extension field includes a parameter indicating a number of UE IDs of a user associated with the first UE ID.

According to an aspect of the present disclosure, a radio unit (RU) device for wireless communication includes one or more processors including processing circuitry, and a memory storing instructions. The instructions, when executed by the one or more processors individually or collectively, cause the RU device to transmit, to a distributed unit (DU), a management-plane message including information about a control-plane message supported by the RU, and receive, from the DU through a fronthaul interface, a first control-plane message during a time period longer than a slot. The first control-plane message includes a field indicating a first user equipment identifier (UE ID) and a first section extension field. The first section extension field includes a parameter indicating a number of UE IDs of a user associated with the first UE ID.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates a wireless communication system, according to an embodiment of the present disclosure;

FIG. 2 illustrates a block diagram of a base station of an open radio access network (O-RAN), according to an embodiment of the present disclosure;

FIG. 3 illustrates a block diagram of a distributed unit (DU), according to an embodiment of the present disclosure;

FIG. 4 illustrates a block diagram of a radio unit (RU), according to an embodiment of the present disclosure;

FIG. 5 illustrates transmit antenna switching (TAS), according to an embodiment of the present disclosure;

FIG. 6 illustrates singular value decomposition (SVD) beamforming, according to an embodiment of the present disclosure;

FIG. 7 illustrates a flowchart of a method for wireless communication, according to an embodiment of the present disclosure;

FIG. 8 illustrates a configuration of a section type, according to an embodiment of the present disclosure;

FIG. 9 illustrates a configuration of a section extension, according to an embodiment of the present disclosure;

FIG. 10 illustrates a configuration of a section extension, according to an embodiment of the present disclosure;

FIG. 11 illustrates a timing of downlink control-plane (C-plane) data transmission/reception between a DU and an RU, according to an embodiment of the present disclosure;

FIG. 12 illustrates a configuration of a section type, according to an embodiment of the present disclosure;

FIG. 13 illustrates a configuration of a section type including a section extension, according to an embodiment of the present disclosure;

FIG. 14 illustrates a configuration of a section type, according to an embodiment of the present disclosure;

FIG. 15 illustrates a configuration of a section type including a section extension, according to an embodiment of the present disclosure;

FIG. 16 illustrates a flowchart of a method for wireless communication performed by a DU, according to an embodiment of the present disclosure; and

FIG. 17 illustrates a flowchart of a method for wireless communication performed by an RU, according to an embodiment of the present disclosure.

### DETAILED DESCRIPTION

The terms used herein are those general terms currently widely used in the art in consideration of functions in the present disclosure, but the terms may vary according to the intentions of those of ordinary skill in the art, precedents, or new technology in the art. Also, in some cases, there may be terms that are optionally selected by the Applicant, and the meanings thereof are described in the corresponding portions of the present disclosure. Thus, the terms used herein may be understood not as simple names but based on the meanings of the terms and the overall description of the present disclosure.

The terms used herein are used to describe particular embodiments and are not intended to limit the scope of the present disclosure. The terms defined in commonly used dictionaries may be interpreted as having the same meanings as the contextual meanings of the related art and may not be interpreted in an idealized or overly formal sense unless expressly so defined herein. In some cases, even the terms defined herein may not be interpreted to exclude the embodiments of the present disclosure.

In various embodiments of the present disclosure described below, a hardware-based approach is described as an example. However, because the various embodiments of the present disclosure may include technologies that may use both hardware and software. That is, the various embodiments of the present disclosure may not exclude a software-based approach.

In the following description, terms referring to signals (e.g., message, information, preamble, signal, signaling, sequence, and stream), terms referring to resources (e.g., symbol, slot, subframe, radio frame, subcarrier, resource element (RE), resource block (RB), bandwidth part (BWP), and occasion), terms for operation states (e.g., step, operation, and procedure), terms referring to data (e.g., packet, user stream, information, bit, symbol, and codeword), terms referring to channels, terms referring to control information (e.g., downlink control information (DCI), medium access control element (MAC CE), and radio resource control (RRC) signaling), terms referring to network entities, terms referring to components of devices, and the like are just examples for convenience of description. Thus, the present disclosure is not limited to the terms described below and any other terms having equivalent technical meanings may be used.

As used herein, the singular forms “a,” “an,” and “the” may include the plural forms as well, unless the context clearly indicates otherwise. Unless otherwise defined, all terms (including technical or scientific terms) used herein may have the same meanings as commonly understood by those of ordinary skill in the art of the present disclosure.

Throughout the present disclosure, when an element is referred to as “including” an element, one or more other elements may be further included unless specified otherwise. Also, as used herein, terms such as “units” and “modules” may refer to units that may perform at least one function or operation, and the units may be implemented as hardware or software or a combination of hardware and software.

The expression “configured to (or set to)” used herein may be replaced with, for example, “suitable for,” “having the capacity to,” “designed to,” “adapted to,” “made to,” or “capable of” according to cases. The expression “configured to (or set to)” may not necessarily mean “specifically designed to” in a hardware level. Instead, in some case, the expression “a system configured to . . . ” may mean that the system is “capable of . . . ” along with other devices or components. For example, “a processor configured to (or set to) perform A, B, and C” may refer to a dedicated processor (e.g., an embedded processor) for performing a corresponding operation, or a general-purpose processor (e.g., a central processing unit (CPU) or an application processor) capable of performing a corresponding operation by executing one or more software programs stored in a memory.

Also, herein, when an element is referred to as being “connected” or “coupled” to another element, the element may be directly connected or coupled to the other element and may also be connected or coupled to the other element through one or more other intervening elements therebetween unless otherwise specified.

Also, herein, the expression “more than” or “less than” may be used to determine whether a particular condition is satisfied or fulfilled. However, this is just a description for representing an example and may not exclude a description of “more than or equal to” or “less than or equal to”. A condition described as “more than or equal to” may be replaced with “more than”, a condition described as “less than or equal to” may be replaced with “less than”, and a condition described as “more than or equal to and less than or equal to” may be replaced with “more than and less than”.

Also, although the present disclosure describes various embodiments by using terms used in some communication standards (e.g., 3rd Generation Partnership Project (3GPP), extensible radio access network (xRAN), and open-radio access network (O-RAN)), these are just examples for description. Various embodiments of the present disclosure may be modified and applied to other communication systems.

Hereinafter, for convenience of description, the present disclosure may use terms and names defined in the 3GPP Long Term Evolution (3GPP LTE) or New Radio (NR) standards or modified terms and names based thereon. However, the present disclosure is not limited to the above terms and names and may also be similarly applied to systems according to other standards. In the present disclosure, eNode B (eNB) may be used interchangeably with gNode B (gNB) for convenience of description. For example, a base station referred to as an eNB may also be understood as a gNB. In the present disclosure, the term “terminal” may refer to not only a user equipment (UE), a mobile station (MS), a mobile phone, narrowband-Internet of Things (NB-IoT) devices, and sensors but also various wireless communication devices.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

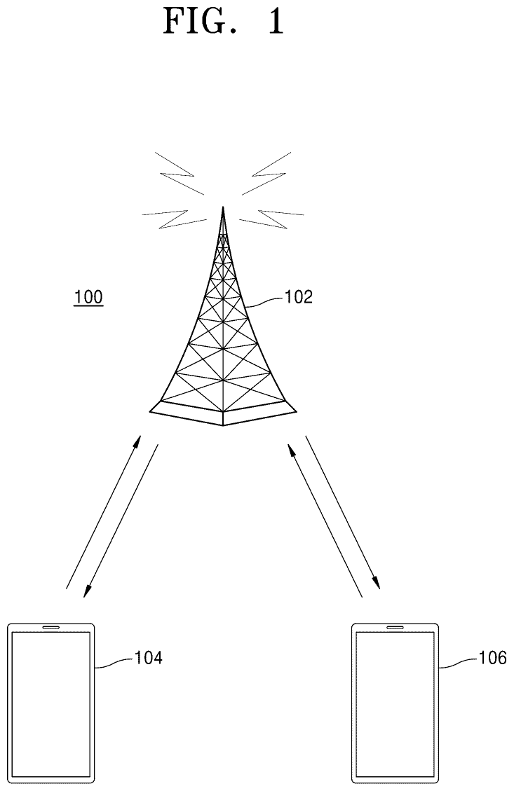

FIG. 1 illustrates a wireless communication system, according to an embodiment of the present disclosure. Referring to FIG. 1, a wireless communication system 100 may include a base station 102, a first terminal 104, and a second terminal 106 as some of the nodes that use a wireless channel in the wireless communication system 100. Although FIG. 1 illustrates only one base station, one or more other base stations that may be substantially similar and/or the same as the base station 102 may be further included. Alternatively or additionally, the wireless communication system 100 may include additional terminals (e.g., three (3) or more) that may be substantially similar and/or may be the same as the first terminal 104 and the second terminal 106.

The base station 102 may be and/or may include a network infrastructure that may provide radio access to the first and second terminals 104 and 106. The base station 102 may have a coverage area that may refer to a certain geographical area based on the distance within which the base station 102 may transmit a signal. The base station 102 may also be referred to as an access point (AP), an eNB, a fifth generation (5G) node, a gNB, a wireless point, a transmission/reception point (TRP), or any other terms having equivalent technical meanings thereof.

Each of the first terminal 104 and the second terminal 106 may be and/or may include a device used by a user and may communicate with the base station 102 through a wireless channel. A link from the base station 102 to the first terminal 104 or the second terminal 106 may be referred to as a downlink (DL). A link from the first terminal 104 or the second terminal 106 to the base station 102 may be referred to as an uplink (UL). Also, the first terminal 104 and the second terminal 106 may communicate with each other through a wireless channel. For example, a device-to-device (D2D) link between the first terminal 104 and the second terminal 106 may be referred to as a sidelink. The sidelink may be referred to interchangeably with a LTE vehicle-to-everything (LTE-V2X or PC5) interface.

In some embodiments, at least one of the first terminal 104 and the second terminal 106 may be operated without involvement by the user. That is, at least one of the first terminal 104 and the second terminal 106 may be a device performing machine type communication (MTC) that may not be carried out by the user. Each of the first terminal 104 and the second terminal 106 may be referred to as a user equipment (UE), a customer premises equipment (CPE), a mobile station, a subscriber station, a remote terminal, a wireless terminal, an electronic device, a user device, or any other terms having equivalent technical meanings thereof.

The base station 102, the first terminal 104, and the second terminal 106 may perform beamforming. The base station 102 and the first and second terminals 104 and 106 may transmit and/or receive wireless signals in a relatively low frequency band (e.g., frequency range 1 (FR1) of NR). Alternatively or additionally, the base station 102 and the first and second terminals 104 and 106 may transmit and/or receive wireless signals in a relatively high frequency band (e.g., FR2 of NR and millimeter wave (mmWave) band (e.g., 28 gigahertz (GHz), 30 GHz, 38 GHz, and 60 GHz)). In some embodiments, the base station 102 may perform communication with the first or second terminal 104 or 106 within a frequency range corresponding to FR1.

In some embodiments, the base station 102 may perform communication with the first or second terminal 104 or 106 within a frequency range corresponding to FR2. In such a case, for improvement of a channel gain, the base station 102, the first terminal 104, and the second terminal 106 may perform beamforming. Here, beamforming may include, but not be limited to, transmission beamforming and/or reception beamforming. For example, the base station 102, the first terminal 104, and the second terminal 106 may give directivity to a transmission signal and/or a reception signal. That is, the base station 102 and the first and second terminals 104 and 106 may select serving beams through a beam search and/or a beam management procedure. However, the present disclosure is not limited in this regard. After the serving beams are selected, subsequent communication may be performed through resources that are in a quasi-co-located (QCL) relationship with resources that have transmitted the serving beams.

Herein, the term beam may refer to a spatial flow of a signal in a wireless channel. For example, a beam of an antenna may be and/or may include a radiation pattern without restriction to a main lobe. A beam may be formed by one or more antennas (or antenna elements) in a forming process that may be referred to as beamforming. Beamforming may include analog beamforming and/or digital beamforming (e.g., precoding). A reference signal transmitted based on beamforming may include, for example, a demodulation-reference signal (DM-RS), a channel state information-reference signal (CSI-RS), a synchronization signal/physical broadcast channel (SS/PBCH), a sounding reference signal (SRS), or the like. Also, a resource element (RE), such as, but not limited to, a CSI-RS resource or an SRS resource, may be used as a configuration for each reference signal, and this configuration may include information associated with the beam. The information associated with the beam may indicate whether the corresponding configuration (e.g., a CSI-RS resource) uses the same spatial domain filter as another configuration (e.g., another CSI-RS resource in the same CSI-RS resource set) or uses a different spatial domain filter, whether the configuration is quasi-co-located (QCL) with a reference signal, or which type (e.g., QCL type A, B, C, or D) the configuration is when quasi-co-located with the reference signal.

When large-scale characteristics of a channel transferring a symbol on a first antenna port may be inferred from a channel transferring a symbol on a second antenna port, the first antenna port and the second antenna port may be evaluated as being in a QCL relationship with each other. For example, the large-scale characteristics may include at least one of a delay spread, a Doppler spread, a Doppler shift, an average gain, an average delay, and a spatial receiver parameter.

Although FIG. 1 illustrates that both the base station 102 and the first and second terminals 104 and 106 perform beamforming, various embodiments of the present disclosure are not necessarily limited thereto. In some embodiments, the first or second terminal 104 or 106 may or may not perform beamforming. Alternatively or additionally, the base station 102 may or may not perform beamforming. That is, only one of the base station 102 and the first and second terminals 104 and 106 may perform beamforming, or both the base station 102 and the first and second terminals 104 and 106 may not perform beamforming.

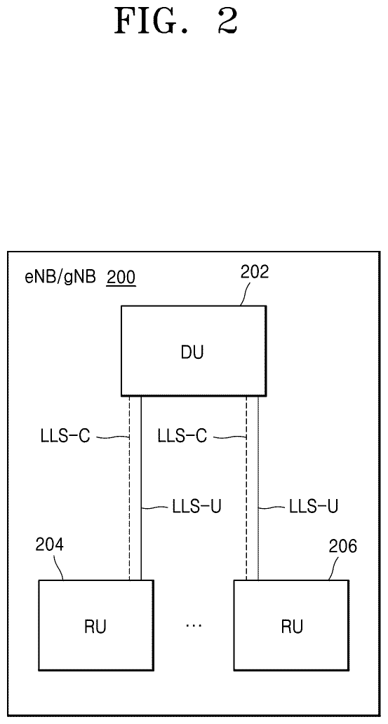

In a related communication system with a relatively large cell radius of a base station, each base station may be installed such that each base station may include the functions of a digital processing unit (or distributed unit (DU)) and a radio frequency (RF) processing unit (or radio unit (RU)). However, as high-frequency bands have been used in the fourth generation (4G) and/or subsequent communication systems (e.g., 5G) and the cell coverage of base stations may have decreased, the number of base stations that may be needed to cover a particular area may have increased. The burden of installation cost on service providers for installing base stations may have also increased. In an attempt to minimize the installation cost of a base station, a structure may have been proposed in which the DU and RU of a base station are separated from each other, one or more RUs are connected to one DU through a wired network, and one or more geographically-distributed RUs are arranged to cover a particular area. Hereinafter, the arrangement structure and extension examples of a base station, according to various embodiments of the present disclosure, are described with reference to FIG. 2.

FIG. 2 illustrates a block diagram of a base station 200 of an open radio access network (O-RAN), according to an embodiment of the present disclosure. The base station 200 may include and/or may be similar in many respects to the base station 102 described above with reference to FIG. 1, and may include additional features not mentioned above. Consequently, repeated descriptions of the base station 200 described above with reference to FIG. 1 may be omitted for the sake of brevity.

Referring to FIG. 2, the base station (eNB and/or gNB) 200 may include a DU 202 and one or more RUs (e.g., a first RU 204 to a second RU 206. A logical link between the DU 202 and the first and second RUs 204 and 206 may be referred to as a fronthaul. For example, the fronthaul may be and/or may include a logical link connecting the DU 202 and the first and second RUs 204 and 206 to each other. The fronthaul may transport traffic of at least one of a control plane (C-plane), a user plane (U-plane), a synchronization plane (S-plane), or a management plane (M-plane). In an embodiment, the fronthaul may be operated through a fronthaul interface (Fx interface). For example, an interface such as, but not limited to, an enhanced common public radio interface (eCPRI) or a radio-over-Ethernet (ROE) interface may be used to operate the fronthaul.

As communication technology may have developed, the amount of mobile data traffic may have increased, and accordingly, a bandwidth demand needed by the fronthaul between a DU and a RU may have also increased. In an arrangement such as centralized/cloud radio access network (C-RAN), the DU 202 may be implemented to perform functions that may include, but not be limited to, packet data convergence protocol (PDCP), radio link control (RLC), media access control (MAC), physical (PHY), or the like. In such an arrangement, the first and second RUs 204 and 206 may be implemented to perform functions for a PHY layer in addition to an RF function.

The DU 202 may manage an upper layer function of a wireless network. For example, the DU 202 may perform a function of the MAC layer and a portion of the PHY layer. As used herein, the portion of the PHY layer may be performed at a high-level among the functions of the PHY layer and may include, for example, channel encoding (or channel decoding), scrambling (or descrambling), modulation (or demodulation), and layer mapping (or layer demapping). In an embodiment, when the DU 202 complies with the O-RAN standard, the DU 202 may be referred to as an O-RAN distributed unit (O-RAN DU or O-DU). The O-DU may be and/or may include a logical node hosting RLC/MAC/High-PHY layers based on a lower layer functional split. In an embodiment, the DU 202 may be replaced with a first network entity for a base station (e.g., gNB).

The first and second RUs 204 and 206 may manage a lower layer function of a wireless network. For example, the first and second RUs 204 and 206 may perform a portion of the PHY layer and an RF function. The portion of the PHY layer may refer to a function from among the functions of the PHY layer that may be performed at a relatively lower level than the DU 202. For example, the portion of the PHY layer may include, but not be limited to, inverse fast Fourier transform (iFFT) (or fast Fourier transform (FFT)), cyclic prefix (CP) insertion (or CP removal), digital beamforming, or the like. The first and second RUs 204 and 206 may be referred to as an access unit (AU), an access point (AP), a transmission/reception point (TRP), a remote radio head (RRH), a radio unit (RU), or any other terms having equivalent technical meanings thereof. In an embodiment, when the first and second RUs 204 and 206 comply with the O-RAN standard, the first and second RUs 204 and 206 may be referred to as an O-RAN radio unit (O-RAN RU or O-RU). The O-RU may be and/or may include a logical node hosting Low-PHY layer and RF processing based on a lower layer functional split. In an embodiment, the first and second RUs 204 and 206 may be replaced with a second network entity (or second network entities) for a base station (e.g., gNB). In an embodiment, the first and second RUs 204 and 206 may be implemented in a similar way to each other and may operate in a similar way.

Although FIG. 2 illustrates that the base station 200 includes a DU 202 and two RUs, various embodiments of the present disclosure are not limited thereto. In some embodiments, the base station 200 may be implemented in a distributed deployment according to a centralized unit (CU) configured to perform functions of upper layers of an access network (e.g., a packet data convergence protocol (PDCP) layer or an RRC layer) and a distributed unit (DU) configured to perform functions of lower layers. The CU may be connected to one or more DUs to perform a function of a high-layer than the DU. In an embodiment, when the CU complies with the O-RAN standard, the CU may be referred to as an O-RAN Central Unit (O-RAN CU or O-CU). The O-CU may be and/or may include a logical node hosting PDCP, RRC, service data adaptation protocol (SDAP), and/or other control functions. Various embodiments of the present disclosure may be applied to both a base station 200 arrangement including a CU or an arrangement in which a DU is directly connected to a core network without a CU (e.g., the CU and the DU may be integrated into a single entity).

In an embodiment, the DU 202 may be implemented as an O-DU, and the first and second RUs 204 and 206 may be implemented as O-RUs. A control path LLS-C and a user path LLS-U may respectively provide a control plane and a user plane through a lower layer split (LLS) interface. For example, the C-plane traffic between the DU 202 and the first and second RUs 204 and 206 may be transported through a lower layer split control plane (LLS-C) interface. The U-plane traffic between the DU 202 and the first and second RUs 204 and 206 may be transported through a lower layer split user plane (LLS-U) interface. The LLS interface may be and/or may include a logical interface between the O-DU and the O-RU when using a lower layer (intra-PHY based) functional split. The LLS-C interface may be and/or may include a logical interface (e.g., for the control plane) between the O-DU and the O-RU when using a lower layer functional split. The LLS-U interface may be and/or may include a logical interface (e.g., for the user plane) between the O-DU and the O-RU when using a lower layer functional split.

As wireless communication technology may have developed (e.g., the introduction of 5G and/or NR communication systems), the frequency bands used may have also increased, and as the cell radius of base stations may have decreased, the number of RUs that may need to be installed may have also increased. In addition, in 5G communication systems, for example, the amount of data transmitted may have significantly increased (e.g., by 10 times or more), and consequently, a transmission capacity of the wired network transmitted through the fronthaul may have also increased. Due to at least these factors, the installation cost of the wired network in a 5G communication system may have increased. Thus, in an attempt to lower the transmission capacity of the wired network and/or reduce the installation cost of the wired network, technologies may have been proposed that may reduce the transmission capacity of the fronthaul by transferring some functions of the modem of the DU to the RU, and these technologies may be referred to as function split.

In an attempt to reduce the burden on the DU, a method may be considered to extend the role of the RU, which may manage only an RF function, to also manage some functions of a physical layer. However, as the RU performs high-layer functions, the processing amount of the RU may increase and thus the transmission bandwidth in the fronthaul may increase and simultaneously the delay constraint due to response processing may decrease. Moreover, as the RU performs high-layer functions, the virtualization gain may decrease and the size/weight/cost of the RU may increase. Considering the trade-offs between the above-discussed advantages and disadvantages, it may be needed to implement an optimal functional split.

Regarding functions in the PHY layer below the MAC layer, in the case of a downlink (DL) for transmitting a signal to a terminal through a wireless network, the base station may sequentially perform at least some of channel encoding/scrambling, modulation, layer mapping, antenna mapping, resource element (RE) mapping, in-phase/quadrature-phase (IQ) compression/decompression, digital beamforming (e.g., precoding), inverse fast Fourier transform (iFFT), CP addition, digital-to-analog conversion (or RF conversion), or analog beamforming. In the case of an uplink (UL) for receiving a signal from a terminal through a wireless network, the base station may sequentially perform at least some of analog beamforming, analog-to-digital conversion (or RF conversion), fast Fourier transform (FFT), CP removal and filtering (e.g., CP removal, decimation filtering, and/or FFT), digital beamforming (e.g., pre-combining), IQ compression/decompression, RE demapping, channel estimation, detection, equalization, inverse Discrete Fourier Transform (IDFT) channel estimation, layer demapping, demodulation, or decoding/descrambling. The split of the uplink functions and the downlink functions may be defined in various types according to the above trade-off by discussion on needs, standards, design constraints, or the like between vendors.

Embodiments of the present disclosure may support various modifications of the functional split. In an embodiment, the RF function and the PHY function may be split. Accordingly, the PHY function may not be substantially implemented in the RU, and this functional split may be referred to as ‘Option 8’. In an embodiment, the RU may perform iFFT/CP insertion in the DL and FFT/CP removal in the UL among the PHY functions, and the DU may perform the other PHY functions. This functional split may be referred to as ‘Option 7-1’. In an embodiment, the RU may perform iFFT/CP insertion in the DL, FFT/CP removal in the UL, and digital beamforming (e.g., precoding) in the UL among the PHY functions, and the DU may perform the other PHY functions. This functional split may be referred to as ‘Option 7-2x Category A’. In an embodiment, the RU may further perform digital beamforming in both the DL and the UL, and the DU may perform high-PHY functions (e.g., the other PHY functions) after digital beamforming. For example, among the PHY functions, the RU may perform iFFT/CP insertion and digital beamforming in the DL and may also perform FFT/CP removal and digital beamforming in the UL. This functional split may be referred to as ‘Option 7-2x Category B’. In an embodiment, the RU may further perform RE mapping (or RE demapping) in both the DL and the UL, and the DU may perform high-PHY functions after RE mapping (or RE demapping). For example, among the PHY functions, the RU may perform iFFT/CP insertion, digital beamforming, and RE mapping in the DL and may also perform FFT/CP removal, digital beamforming, and RE demapping in the UL. This functional split may be referred to as ‘Option 7-2’. In an embodiment, the RU may further perform at least some of antenna port mapping, layer mapping, and modulation (or demodulation) in both the DL and the UL, and the DU may perform high-PHY functions after modulation (or demodulation). For example, among the PHY functions, the RU may perform iFFT/CP insertion, digital beamforming, RE mapping, antenna port mapping, layer mapping, and modulation in the DL and may also perform FFT/CP removal, digital beamforming, RE demapping, channel estimation, layer demapping, and demodulation in the UL. This functional split may be referred to as ‘Option 7-3’. In an embodiment, the RU may further perform encoding/scrambling (or decoding/descrambling) in both the DL and the UL, and the DU may perform subsequent high-PHY functions. For example, among the PHY functions, the RU may perform iFFT/CP insertion, digital beamforming, RE mapping, antenna port mapping, layer mapping, modulation, and channel encoding/scrambling in the DL and may also perform FFT/CP removal, digital beamforming, RE demapping, channel estimation, layer demapping, demodulation, and decoding/descrambling in the UL. This functional split may be referred to as ‘Option 6’.

In the present disclosure, the high-PHY may refer to physical layer processing processed in the DU of a fronthaul interface. For example, the high-PHY functions may include forward error correction (FEC), encoding/decoding, scrambling/descrambling, and/or modulation/demodulation. Also, the low-PHY may refer to physical layer processing processed in the RU of a fronthaul interface. For example, the low-PHY functions may include FFT/iFFT, digital beamforming, and/or physical random access channel (PRACH) extraction and filtering.

In an embodiment, when a large amount of signal processing is expected such as in an FR1 massive multi-input multi-output (MIMO) unit (FR1 MMU), the functional split at a relatively high layer (e.g., Option 7-2x Category B) may be needed to potentially reduce the fronthaul capacity. Also, because the functional split at a relatively high layer (e.g., option 7-3) may complicate a control interface and a plurality of PHY processing blocks may be included in the RU to cause a burden on the implementation of the RU, a suitable functional split may be needed depending on the arrangement and implementation of the DU and the RU.

In an embodiment, when it is impossible to process precoding of data received from the DU (e.g., when the RU has a limited precoding capability), Option 7-2x Category A or lower functional split (e.g., Option 7-1) may be applied. Alternatively, when it is possible to process precoding of data received from the DU, Option 7-2x Category B or high-functional split (e.g., Option 7-3) may be applied.

In an embodiment following the O-RAN standard, Option 7-2x Category A and Option 7-2x Category B may be supported with respect to the functional split. Option 7-2x Category A and Option 7-2x Category B may be distinguished based on whether the O-RU may execute a precoding operation on data received from the O-DU. An O-RU in which precoding is not performed (e.g., complexity is low) may be referred to as ‘Category A’ O-RU, and an O-RU in which precoding is performed may be referred to as ‘Category B’ O-RU. The O-DU may support Category A O-RU for eight (8) transmission streams or less. That is, the O-DU may support precoding for up to eight (8) transmission streams. When Option 7-2x Category B is applied, the O-DU may transmit information about modulation symbols, on which layer mapping has been completed, and beamforming information to the O-RU, and the O-RU may convert the modulation symbols into analog signals by applying beamforming to the modulation signals and transmit the analog signals to the terminal through an antenna.

Information that may be transmitted from the O-DU to the O-RU in Option 7-2x may include at least some of information transmitted on the management plane, information transmitted on the synchronization plane, information transmitted on the control plane, or information transmitted on the user plane. The information transmitted on the management plane may be transmitted in both the DL and UL directions as non-real-time transmission and may include information for initial setup and/or reset between the O-DU and the O-RU. The information transmitted on the synchronization plane may be transmitted in substantially real time (e.g., substantially simultaneously) and may include information for synchronization or timing between the O-DU and the O-RU. The information transmitted on the control plane may be transmitted in the DL direction as real-time transmission and may include information for the O-DU to transmit a scheduling and/or beamforming command to the O-RU. The information transmitted on the user plane may be transmitted in both the DL and UL directions as real-time transmission and may include DL frequency domain IQ data (including a synchronization signal block (SSB) and a reference signal), UL frequency domain IQ data (including a reference signal such as, but not limited to, an SRS), and frequency domain IQ data about a physical random access channel (PRACH). The above ‘information’ or ‘data’ may be used interchangeably with the term ‘message’.

In an embodiment of the present disclosure, when transmitting a message between the DU 202 and the first or second RU 204 or 206, the standard of eCPRI and O-RAN may be illustratively described as a fronthaul interface. For example, an Ethernet payload of the message may include an eCPRI header, an O-RAN header, and/or an additional field. Hereinafter, an embodiment of the present disclosure is described by using the standard terms of eCPRI or O-RAN. However, any other expressions having equivalent meanings to each term may be used instead in an embodiment of the present disclosure.

The application protocol of the fronthaul may include a control plane, a user plane, a synchronization plane, and a management plane. The transport protocol of the fronthaul may use Ethernet and/or eCPRI that may be able to communicate with the network. For example, an eCPRI header and an O-RAN header may be included in the Ethernet payload. The eCPRI header (or eCPRI transport common header) may be located at the front end of the Ethernet payload.

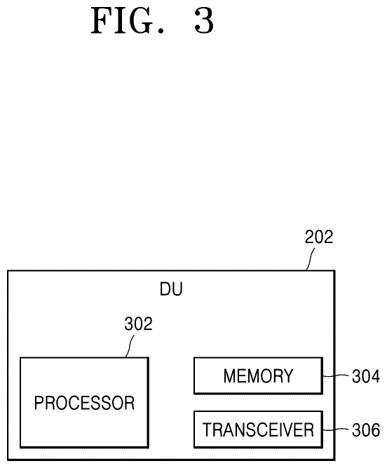

FIG. 3 illustrates a block diagram of a DU 202, according to an embodiment of the present disclosure.

Referring to FIG. 3, the DU 202 may include a processor 302, a memory 304, and a transceiver 306. The configuration of the DU 202 illustrated in FIG. 3 is just an example, and an example of the DU performing an embodiment of the present disclosure is not limited to the configuration illustrated in FIG. 3. According to an embodiment, some configurations may be added, deleted, or modified. In an embodiment, the DU 202 may be understood as an electronic device performing functions as a DU.

The processor 302 may control overall operations of the DU 202. For example, the processor 302 may transmit and/or receive signals through the transceiver 306. The processor 302 may write data in the memory 304 and/or read the data written in the memory 304. The processor 302 may perform functions of a protocol stack needed by a communication standard. In an embodiment, the processor 302 may include one or more processors including processing circuitry. In some embodiments, the processor 302 may be configured to generate a control message including a section extension field. The processor 302 may control the transceiver 306 to transmit the generated control message to the first and second RUs 204 and 206. Additionally or alternatively, the processor 302 may control the DU 202 to perform at least some of the operations, according to an embodiment described below.

In an embodiment, the processor 302 may execute one or more instructions of the program stored in the memory 304. Although FIG. 3 illustrates the processor 302 one element, the present disclosure is not limited thereto. In an embodiment of the present disclosure, the processor 302 may include one or more elements. For example, the processor 302 may be implemented as a general-purpose processor such as, but not limited to, a central processing unit (CPU), an application processor (AP), or a digital signal processor (DSP), a graphics-only processor (e.g., a graphics processing unit (GPU) or a vision processing unit (VPU)), or an artificial intelligence-only processor (e.g., a neural processing unit (NPU)).

The processor 302 may include various processing circuits and/or a plurality of processors. For example, the term ‘processor’ used in the present disclosure, including the claims, may include at least one processor and may additionally or alternatively include various processing circuits. One or more processors may be configured to perform the various functions described in the present disclosure, individually and/or collectively in a distributed manner. As used herein, the “processor”, “at least one processor”, or “one or more processors” may be configured to perform various functions. However, these terms may cover, without limitation, a situation in which a processor may perform some of the functions and another processor or other processors may perform some others of the functions and a situation in which a single processor may perform all of the functions. Also, the at least one processor may include a combination of processors that perform various functions of the described functions in a distributed manner. The at least one processor may individually or collectively execute program instructions to achieve or perform various functions.

The memory 304 may store instructions, data structures, and program codes readable by the processor 302. For example, the memory 304 may store data such as a basic program, an application program, or configuration information for operation of the DU 202. In an embodiment, the memory 304 may store instructions that may be individually or collectively executed by the processor 302 to cause the DU 202 to perform at least some of the operations of the DU 202 described below. For example, the processor 302 may perform at least some of the operations of the DU 202 described in the present disclosure by executing one or more instructions or codes stored in the memory 304.

The memory 304 may include a flash memory type memory, a hard disk type memory, a multimedia card micro type memory, a card type memory, or the like, and may include a nonvolatile memory including, but not limited to, at least one of a read-only memory (ROM), an electronically erasable programmable read-only memory (EEPROM), a programmable read-only memory (PROM), a magnetic memory, a magnetic disk, an optical disk, or the like, and/or a volatile memory such as, but not limited to, a random-access memory (RAM) a static random-access memory (SRAM), or the like.

In an embodiment, the transceiver 306 may perform functions for transmitting and/or receiving signals in a wired communication environment. The transceiver 306 may include a wired interface for controlling direct connection between devices through a transmission medium (e.g., copper wire or optical fiber). For example, the transceiver 306 may transfer an electrical signal to another device (e.g., the first or second RU 204 or 206) through a copper wire and/or may perform conversion between an electrical signal and an optical signal. The transceiver 306 may be connected to the first RU 204. Alternatively or additionally, the transceiver 306 may be connected to a core network and/or may be connected to a CU in a distributed arrangement.

In an optional or additional embodiment, the transceiver 306 may perform functions for transmitting and/or receiving signals in a wireless communication environment. For example, the transceiver 306 may perform a conversion function between a baseband signal and a bit string according to the physical layer standard of the system. For example, during data transmission, the transceiver 306 may generate complex symbols by encoding and/or modulating a transmission bit string. Also, during data reception, the transceiver 306 may restore a reception bit string by demodulating and decoding a baseband signal. For example, the transceiver 306 may upconvert a baseband signal into an RF band signal and transmit the RF band signal through an antenna, and/or may downconvert an RF band signal received through an antenna into a baseband signal. For example, the transceiver 306 may include a transmission filter, a reception filter, an amplifier, a mixer, an oscillator, a digital-to-analog converter (DAC), an analog-to-digital converter (ADC), or the like. Also, the transceiver 306 may include a plurality of transmission and reception paths. Also, according to an embodiment, the transceiver 306 may be connected to the core network and/or may be connected to other nodes (e.g., integrated access backhaul (IAB)).

The transceiver 306 may include an antenna unit. The transceiver 306 may include at least one antenna array including a plurality of antenna elements. In terms of hardware, the transceiver 306 may include a digital circuit and/or an analog circuit (e.g., a radio frequency integrated circuit (RFIC)). In an embodiment, the digital circuit and/or the analog circuit may be implemented in a single package. The transceiver 306 may include a plurality of RF chains. The transceiver 306 may perform beamforming. In order to give directivity according to the settings of the processor 302 to signals to be transmitted/received, the transceiver 306 may apply beamforming weights to the signals. According to an embodiment, the transceiver 306 may include a radio frequency (RF) block (or an RF unit). The transceiver 306 may transmit a synchronization signal, a reference signal, system information, a message, a control message, a stream, control information, data, or the like.

The transceiver 306 may transmit and/or receive signals as described above. Accordingly, all or part of the transceiver 306 may be referred to as a ‘transmitter’, a ‘receiver’, or a ‘transceiver unit’. Also, in the following description, transmission and reception performed through a wireless channel may be used to refer to the processing described above as performed by the transceiver 306.

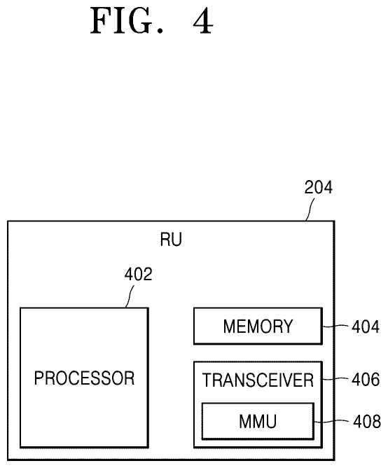

FIG. 4 illustrates a block diagram of a first RU 204, according to an embodiment of the present disclosure.

Referring to FIG. 4, the first RU 204 may include a processor 402, a memory 404, and a transceiver 406. The configuration of the first RU 204 illustrated in FIG. 4 is just an example, and an example of the RU performing an embodiment of the present disclosure is not limited to the configuration illustrated in FIG. 4. According to an embodiment, some configurations may be added, deleted, or modified. In an embodiment, the first RU 204 may be understood as an electronic device performing functions as an RU.

The processor 402 may control overall operations of the first RU 204. For example, the processor 402 may transmit and/or receive signals through the transceiver 406. The processor 402 may write data in the memory 404 and/or read the data written in the memory 404. The processor 402 may perform functions of a protocol stack that may be needed by a communication standard. In an embodiment, the processor 402 may include at least one processor including processing circuitry. In some embodiments, the processor 402 may be configured to receive a control message including a section extension field. For example, the processor 402 may control the transceiver 406 to receive a control message from the DU 202. Based on the received control message, the processor 402 may control the transceiver 406 to perform beamforming. Additionally or alternatively, the processor 402 may control the first RU 204 to perform at least some of the operations, according to an embodiment described below. In an embodiment, the processor 402 may be implemented in a similar way to the processor 302 of FIG. 3.

The memory 404 may store instructions, data structures, and/or program codes readable by the processor 402. For example, the memory 404 may store data such as, but not limited to, a basic program, an application program, or configuration information for operation of the first RU 204. In an embodiment, the memory 404 may store instructions that may be individually or collectively executed by the processor 402 to cause the first RU 204 to perform at least some of the operations of the first RU 204 described below. For example, the processor 402 may perform at least some of the operations of the first RU 204 described in the present disclosure by executing one or more instructions or codes stored in the memory 404. In an embodiment, the memory 404 may be implemented in a similar way to the memory 304 of FIG. 3.

The transceiver 406 may perform functions for transmitting and/or receiving signals through a wireless channel. For example, the transceiver 406 may upconvert a baseband signal into an RF band signal and transmit the RF band signal through an antenna, and/or may downconvert an RF band signal received through an antenna into a baseband signal. For example, the transceiver 406 may include a transmission filter, a reception filter, an amplifier, a mixer, an oscillator, a digital-to-analog converter (DAC), an analog-to-digital converter (ADC), or the like.

Also, the transceiver 406 may include a plurality of transmission/reception paths. Furthermore, the transceiver 406 may include an antenna unit. In terms of hardware, the transceiver 406 may include a digital circuit and/or an analog circuit (e.g., an RFIC). In an embodiment, the digital circuit and/or the analog circuit may be implemented in a single package. Also, the transceiver 406 may include a plurality of RF chains.

The transceiver 406 may include a massive multi-input multi-output (MIMO) unit 408. The MMU 408 may include at least one antenna array including a plurality of antenna elements. The MMU 408 may perform beamforming. In order to give directivity according to the settings of the processor 402 to signals to be transmitted/received, the MMU 408 may apply beamforming weights to the signals. The MMU 408 may simultaneously transfer data to a plurality of users (or counterpart devices). In an embodiment, the MMU 408 may include a radio frequency (RF) block (or an RF unit). In an embodiment, the MMU 408 may perform channel estimation on the channel between the base station 200 and another device. For example, the MMU 408 may estimate the characteristics of the channel between the terminal and the base station 200 based on the SRS received from the terminal.

The transceiver 406 may transmit/receive signals. The transceiver 406 may transmit a downlink signal. The downlink signal may include, but not be limited to, a synchronization signal (SS), a reference signal (RS) (e.g., a cell-specific reference signal (CRS), a demodulation (DM)-RS), system information (e.g., master information block (MIB), system information block (SIB), remaining system information (RMSI), other system information (OSI)), configuration message, control information, downlink data, or the like. Also, the transceiver 406 may receive an uplink signal. The uplink signal may include a random access-related signal (e.g., a random access preamble (RAP), message 1 (Msg1), or message 3 (Msg3)), a reference signal (e.g., SRS or DM-RS), or a power headroom report (PHR).

The transceiver 406 may transmit and/or receive signals as described above. Accordingly, all or part of the transceiver 406 may be referred to as a ‘transmitter’, a ‘receiver’, or a ‘transceiver unit’. Also, in the following description, transmission and reception performed through a wireless channel may be used to refer to the processing described above as performed by the transceiver 406.

The second RU 206 may include and/or may be similar in many respects to the first RU 204 described above with reference to FIGS. 2 and 4, and may include additional features not mentioned above. Consequently, repeated descriptions of the second RU 206 described above with reference to FIGS. 2 and 4 may be omitted for the sake of brevity.

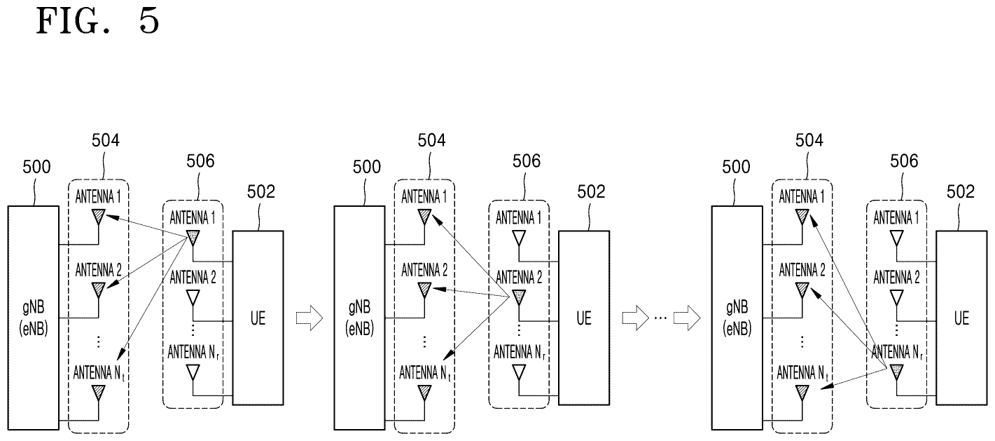

FIG. 5 illustrates transmit antenna switching (TAS), according to an embodiment of the present disclosure.

Referring to FIG. 5, a base station 500 may include Nₜ antennas 504, and a UE 502 may include Nᵣ antennas 506 (where Nₜ and Nᵣ are positive integers greater than zero (0)). The base station 500 may include and/or may be similar in many respects to the base station 102 and the base station 200 described above with reference to FIG. 1 to 3, and may include additional features not mentioned above. Furthermore, the UE 502 may include and/or may be similar in many respects to the first terminal 104 and the second terminal 106, described above with reference to FIG. 1, and may include additional features not mentioned above. Consequently, repeated descriptions of the base station 500 and the UE 502 described above with reference to FIG. 1 to 3 may be omitted for the sake of brevity.

The UE 502 may transmit a signal (e.g., SRS) to the base station 500 by using at least some of the Nᵣ antennas 506. For example, the UE 502 may include a transmission circuit including at least one of a power amplifier (PA), a low noise amplifier (LNA), a duplexer, a switch, or a filter. The base station 500 may perform channel estimation on one or more channels between the base station 500 and the UE 502, based on the signals received from the UE 502.

When the UE 502 transmits an SRS to the base station 500, it may be difficult to use the Nᵣ antennas 506 simultaneously. Accordingly, in an attempt to transmit an SRS, the UE 502 may perform a TAS operation to switch the Nᵣ antennas 506. According to the TAS operation, the UE 502 may sequentially connect the transmission circuit to the Nᵣ antennas 506. For example, the UE 502 may transmit an SRS to the base station 500 by using a first antenna and re-transmit an SRS to the base station 500 by using a second antenna. Thus, the UE 502 may transmit an SRS Nᵣ times by performing a TAS operation.

The base station 500 may receive an SRS by using the Nₜ antennas 504 simultaneously. Based on up to Nᵣ SRS receptions using the Nₜ antennas 504, the base station 500 may obtain an Nᵣ×Nₜ channel matrix. For example, the base station 500 may estimate one or more characteristics of each of one or more channels between the UE 502 and the base station 500 based on the received SRSs and obtain a channel matrix as a result thereof.

The SRS may be periodically transmitted throughout the frequency domain. However, the present disclosure is not limited in this regard. For example, the SRS may be transmitted aperiodically and/or based on an event (e.g., on demand). The base station 500 may receive an SRS and estimate a channel state in a particular frequency resource. The base station 500 may calculate one or more channel state information elements such as, but not limited to, path loss, signal attenuation, delay spread, reflection, multipath fading, Doppler shift, signal-to-noise ratio (SNR), and signal-to-interference-plus-noise ratio (SNR) based on the received SRS. By using the periodically-transmitted SRS, the base station 500 may periodically update the channel state information. By using the obtained channel information, the base station 500 may perform beamforming and/or optimize resource allocation.

In an embodiment, the channel matrix may be a channel state information (CSI) matrix between the reception antennas of the base station 500 (e.g., the Nₜ antennas 504) and the transmission antennas of the UE 502 (e.g., the Nᵣ antennas 506). The base station 500 may use advanced beamforming for co-channel and inter-user interference mitigation. In an embodiment, the base station 500 may use singular value decomposition (SVD) beamforming. For example, the base station 500 may design a precoding matrix by applying SVD to an estimated channel (e.g., a channel matrix).

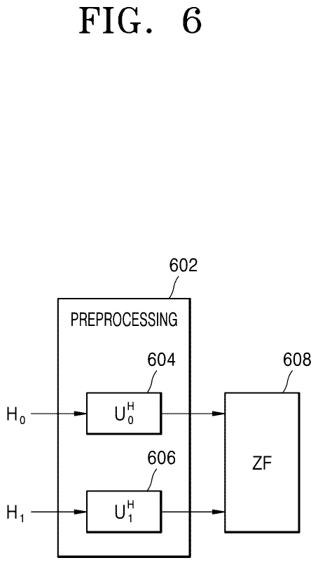

FIG. 6 illustrates SVD beamforming, according to an embodiment of the present disclosure.

Referring to FIG. 6, the base station 500 of FIG. 5 may apply SVD to an Nᵣ×Nₜ channel matrix. SVD may refer to a process of factorizing a real and/or complex matrix into individual matrixes. SVD may be used to decompose the MIMO channel into independent and/or parallel subchannels. As described above with reference to FIG. 5, when the UE 502 supports a TAS function for SRS transmission, the base station 500 may obtain different channel information corresponding to each transmission antenna. All channel information that may be identified by a unique ueId (e.g., UE identifier or UE ID) may be used for beamforming weight calculation. The base station 500 may specify which of these channel matrixes belong to the UE 502, and may use an advanced beamforming algorithm (e.g., SVD-based beamforming) to mitigate co-channel interference and potentially improve transmission reliability.

By applying SVD, the channel matrix may be decomposed into an Nᵣ×Nᵣ orthogonal matrix U, an Nᵣ×Nₜ matrix Σ having only non-negative diagonal elements, and an Nₜ×Nₜ orthogonal matrix V. For example, the base station 500 may apply SVD based on an equation that may be represented as an equation similar to Equation 1.

$$H = U Σ {V}^{H} \qquad [ Equation 1 ]$$

Referring to Equation 1, H may represent a matrix for an estimated channel. For example, H may be the Nᵣ×Nₜ channel matrix obtained in FIG. 5. The matrix Σ may represent a diagonal matrix including singular values, and each singular value may correspond to a channel gain. The matrix U and the matrix V may represent unitary matrixes. V^{H} may represent a Hermitian matrix of the matrix V. For example, V^{H} may represent a singular vector in the transmission direction.

In block 602, the base station 500 may preprocess the received signal by using the matrix U derived by using an equation similar to Equation 1. The base station 500 may preprocess the received signal by using the Hermitian matrix U^{H} of the matrix U. For example, the base station 500 may obtain a matrix G=U^{H}H for a given channel matrix H. In an embodiment, when the matrix H is decomposed through SVD as in Equation 1, the matrix G may be represented as G=U^{H}H=U^{H}UΣV^{H}=ΣV^{H}. The matrix G may represent an effective channel preprocessed in a diagonalized state of the channel matrix. By using the matrix G, zero-forcing (ZF) beamforming may be performed in block 608.

For example, by applying SVD to a channel matrix H₀, the base station 500 may obtain a matrix U₀ corresponding to the channel matrix H₀ and a Hermitian matrix U₀^{h} 604 of U₀. By applying SVD to a channel matrix H₁, the base station 500 may obtain a matrix U₁ corresponding to a channel matrix H₁ and a Hermitian matrix U₁^{H} 606 of U₁. In block 602, by using the matrixes H₀, H₁, U₀^{H} 604, and U₁^{H} 606, the base station 500 may obtain a matrix G using an equation similar to Equation 2. Referring to Equation 2, G₀ may represent a channel corresponding to the channel matrix H₀, and G₁ may represent a channel corresponding to the channel matrix H₁.

$$G [ \begin{matrix}{G}_{0} \\ {G}_{1}\end{matrix} ] = [ \begin{matrix}{U}_{0}^{H} & {H}_{0} \\ {U}_{1}^{H} & {H}_{1}\end{matrix} ] \qquad [ Equation 2 ]$$

In block 608, ZF beamforming may be performed based on the matrix G. Accordingly, a reception signal y may be represented as an equation similar to Equation 3.

$$y = HWx = [ \begin{matrix}{U}_{0} & 0 \\ 0 & {U}_{1}\end{matrix} ] {{GG}^{H} ( {GG}^{H} )}^{- 1} [ \begin{matrix}{x}_{0} \\ {x}_{1}\end{matrix} ] = [ \begin{matrix}{U}_{0} & {x}_{0} \\ {U}_{1} & {x}_{1}\end{matrix} ] , \qquad [ Equation 3 ]$$

$$where H = [ \begin{matrix}{H}_{0} \\ {H}_{1}\end{matrix} ] = [ \begin{matrix}{U}_{0} & 0 \\ 0 & {U}_{1}\end{matrix} ] G$$

Referring to Equation 3, y may represent a reception signal, a matrix W may represent a beamforming matrix (or a precoding matrix), and x may represent a transmission signal. For example, the matrix W may be based on the matrix G obtained through SVD and ZF beamforming. Continuing to refer to Equation 3, the obtaining of the matrix G may correspond to W=G^{H}(GG^{H})⁻¹.

In an embodiment, the matrix H₀ may represent channel information corresponding to the first antenna of the transmitter, and the matrix H₁ may represent channel information corresponding to the second antenna of the transmitter. For example, the matrix H₀ may include information associated with the channel between antenna 1 of the UE 502 and the base station 500 of FIG. 5, and the matrix H₁ may include information associated with the channel between antenna 2 of the UE 502 and the base station 500. Accordingly, the base station 500 may perform SVD beamforming for each channel with respect to each antenna of the UE 502. In an embodiment, H₀ may be a channel matrix at a first time point, and the matrix H₁ may be a channel matrix at a second time point. In an embodiment, H₀ may be a channel matrix between the base station 500 and the first UE (e.g., the UE 502), and the matrix H₁ may be a channel matrix between the base station 500 and the second UE.

In an embodiment, SVD beamforming may refer to beamforming based on SVD, and performing SVD processing may include applying SVD to the channel matrix H. In an embodiment, the performing of the beamforming may include obtaining (or calculating or deriving) a matrix G based on the channel matrix H and the corresponding matrix U in block 602 and applying ZF beamforming in block 608. Accordingly, by performing beamforming, the reception signal y of Equation 3 may be obtained.

In order to perform SVD beamforming in FIG. 6, the channel matrix H may need to be obtained in advance. For example, in order to perform SVD beamforming, the base station 500 may need to perform channel estimation in advance. In an embodiment, in the base station 200 of FIG. 2, channel estimation may be performed in the DU 202, and SVD beamforming may be performed in the first or second RU 204 or 206. Thus, in order to perform SVD beamforming, the DU 202 may need to provide channel information including the channel matrix H to the first or second RU 204 or 206. In an embodiment, in the base station 200, channel estimation and SVD beamforming may be performed in the first or second RU 204 or 206. Thus, the DU 202 may need to transmit a command to the first or second RU 204 or 206 to perform channel estimation and SVD beamforming.

When the UE 502 supports TAS, as shown in FIG. 5, the first RU 204 of the base station 500 may perform SVD beamforming based on the channel information collected for each antenna 506 of the UE 502. In order to indicate the antenna of the UE 502 associated with the channel information, an identifier of the UE 502 and an identifier indicating a corresponding antenna from among the antennas 506 of the UE 502 may be needed. Thus, in order to perform SVD beamforming, the first RU 204 may need to obtain information including the identifier of the UE 502 and the identifiers of the antennas 506 of the corresponding UE 502 together with the channel information from the DU 202. In response to obtaining the channel information and the information for identifying each antenna of the UE 502, the first RU 204 may perform SVD beamforming.

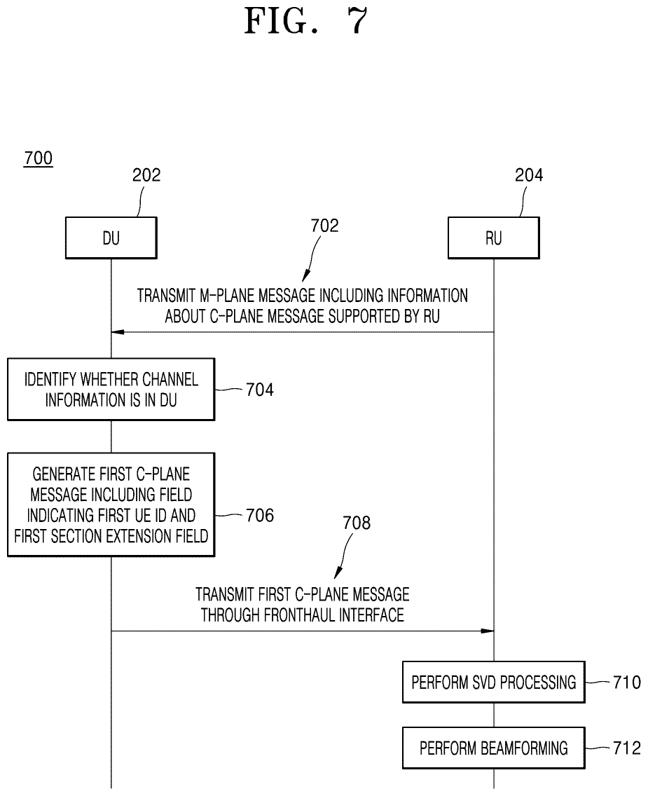

FIG. 7 illustrates a flowchart of a method for wireless communication, according to an embodiment of the present disclosure.

Referring to FIG. 7, the method 700 for wireless communication may be performed by the DU 202 and the first RU 204. However, the present disclosure is not limited thereto, and operations 702 to 712 may be individually or collectively performed by any electronic device (e.g., the second RU 206). The method 700 for wireless communication, according to an embodiment of the present disclosure, is not limited to that illustrated in FIG. 7, and any of the operations illustrated in FIG. 7 may be omitted or operations not illustrated in FIG. 7 may be further included. In some embodiments, the order of at least some of operations 702 to 712 may be modified.

In operation 702, the first RU 204 may transmit, to the DU 202, an M-plane message including information about a C-plane message supported by the first RU 204. The information about the C-plane message may include information indicating whether the MMU 408 supports the C-plane messages of a particular section type including a particular section extension.

In operation 704, the DU 202 may identify whether channel information is in the DU 202. For example, the DU 202 may identify whether a channel estimation result is in the DU 202. Based on the channel estimation result in the DU 202, the DU 202 may identify that channel information is in the DU 202. The DU 202 may identify whether the DU 202 has performed channel estimation and the channel matrix H is stored in the memory 304 of the DU 202 as a result thereof. Based on the channel matrix H stored in the memory 304, the DU 202 may identify that channel information is in the DU 202.

In an embodiment, based on the channel estimation result not being in the DU 202 or the channel matrix H not being stored in the memory 304, the DU 202 may identify whether a channel estimation function is allocated to the DU 202 or the first RU 204. For example, the DU 202 may identify whether the MMU 408 of the first RU 204 may perform channel estimation. Based on the channel estimation function being allocated to the DU 202, the DU 202 may perform channel estimation, store the result of the channel estimation (e.g., channel information) in the memory 304, and identify that channel information in the DU 202. Based on the channel estimation function being allocated to the first RU 204, the DU 202 may identify that channel information is not in the DU 202.

In operation 706, the DU 202 may generate a first C-plane message including a field indicating a first UE identifier (UE ID) and a first section extension field. For example, the first C-plane message may be a section type including a field indicating a first UE ID. Information included in the section type and the first section extension field of the first C-plane message is described below.

In an embodiment, based on identifying that channel information is in the DU 202, the DU 202 may generate a first C-plane message including channel information per UE. In an embodiment, based on identifying that channel information is not in the DU 202, the DU 202 may generate a first C-plane message including a field for commanding the first RU 204 to perform a channel estimation operation.

In operation 708, the DU 202 may transmit the first C-plane message to the first RU 204 through the fronthaul interface. For example, the DU 202 may transmit the first C-plane message during a transmission window for the control plane. The first control-plane message may be transmitted at a period longer than a slot. For example, the transmission period of the first C-plane message may be longer than a period of a slot. The DU 202 may transmit the first C-plane message regardless of the transmission window for the control plane.

In operation 710, the first RU 204 may perform SVD processing. For example, by using the information included in the first C-plane message, the first RU 204 may perform the SVD processing described with reference to FIG. 6. In an embodiment, the first C-plane message may include channel information, and the first RU 204 may perform SVD processing by using the channel information included in the first C-plane message. In an embodiment, the first C-plane message may request the first RU 204 to perform channel estimation, and in response to the first C-plane message, the first RU 204 may perform channel estimation and perform SVD processing based on the channel estimation result.

In operation 712, the first RU 204 may perform beamforming. For example, the first RU 204 may obtain a matrix (or matrixes) associated with the channel information through operation 710. By using the matrix (or matrixes) obtained in operation 710, the first RU 204 may perform beamforming. For example, the first RU 204 may perform the SVD-based beamforming (e.g., ZF beamforming) described above with reference to FIG. 6. The first RU 204 may calculate a suitable beamforming weight for a particular slot based on the SVD and/or ZF.

The SVD beamforming performed based on operations 710 and 712 may be included in channel information-based beamforming. The DU 202 may provide per-UE channel information to the first RU 204 periodically (e.g., less frequently than every slot) by using a C-plane message of a particular section type. The DU 202 may provide scheduling information to the first RU 204 on a slot-by-slot basis by using a C-plane message of a particular section type. By using the scheduling information together with the channel information, the first RU 204 may calculate suitable beamforming weights for co-scheduled UEs with respect to the corresponding slot (e.g., as described with reference to FIGS. 5 to 7).

As illustrated in FIG. 7, the C-plane message may be exchanged between the DU 202 and the first RU 204. The C-plane messages may transmit data-associated control information (e.g., scheduling and beamforming commands) needed for processing user data. A common frame format including a transport layer and an application layer may be used for the C-plane messages. The transport layer may include an eCPRI common header or an Institute of Electrical and Electronics Engineers (IEEE) 1914.3 common header including a corresponding field used to represent the message type, and the application layer may include a field needed for control and synchronization. In the application layer, a section may indicate the characteristics of U-plane data transferred and/or received in a beam with a pattern ID. The application layer may be in the transport layer payload and may include a common header for time reference and may be followed by information and/or parameters depending on the section type in use. A plurality of sets of section data with the same section type value may be lined up one after another (e.g., in a sequence) in the payload. A set of section data with different section type values may be transmitted in a separate C-plane message (e.g., different section type values may not be mixed in a single C-plane message payload).

A section type may indicate the type of a message transmitted on the control plane. The section type may represent the type of a control message transmitted on the control plane. For example, each section type may be as described in Table 1.

TABLE 1

| Section | | |
|---|---|---|
| Type | Target Scenario | Remarks |
| 0 | Unused Resource | Indicates to the O-RU that certain Resource Blocks or |
| | Blocks or symbols in | symbols will not be used (idle periods, guard |
| | Downlink or Uplink | periods). Likewise, there are no associated U-Plane |
| | | message containing IQ data for this Section Type. |
| | | The purpose is to inform the O-RU that transmissions |
| | | may be halted during the specified idle interval for, |
| | | e.g., power-savings or to provide an interval for |
| | | calibration. |
| 1 | Most DL/UL radio | Here, “most” refers to channels not requiring time or |
| | channels | frequency offsets such as needed for mixed- |
| | | numerology channels |
| 2 | Reserved for future use | |
| 3 | PRACH and mixed- | Channels requiring time or frequency offsets or |
| | numerology channels | different-than-nominal SCS values |
| 4 | Slot Configuration | Slot configuration for multiple eAxC_IDs with one or |
| | Control | multiple Section Type 4 configuration commands |
| 5 | UE scheduling | Provides scheduling information for ueIds |
| | information (ueID (UE | |
| | Identifier) assignment to | |
| | section) | |
| 6 | Channel information | Sends UE-specific channel information from the O- |
| | | DU to the O-RUE |
| 7 | LAA (License Assisted | Messages communicated between the O-DU and the |
| | Access) | O-RU in both directions to configure LBT (Listen- |
| | | Before-Talk) for PDSCH (Physical downlink shared |
| | | channel)/DRS (Discovery Reference Signal) |
| | | transmission and to report the LBT outcome |
| 8 | ACK/NACK Feedback | Sent from the O-RU to the O-DU, providing |
| | | ACK/NACK feedback for section descriptions in C- |
| | | Plane messages |
| 9 | SINR (Signal-to- | Reporting of post-equalization SINR values to the O- |
| | Interference-plus-Noise | DU; applicable for DMRS-BF-EQ (DMRS based |
| | Ratio) Report | beamforming with equalization) |
| 10 | RRM (radio resource | RRM measurement report sent from O-RU to O-DU. |
| | management) | Multiple reports of different types can be sent in the |
| | measurement reports | same section. |
| 11 | Request RRM | Sent by O-DU to request O-RU to perform one or |
| | measurements | more RRM measurements. |
| 12-255 | Reserved for future use | |

Hereinafter, the configurations of section types and the configurations of section fields for control messages, according to some embodiments of the present disclosure, are described.

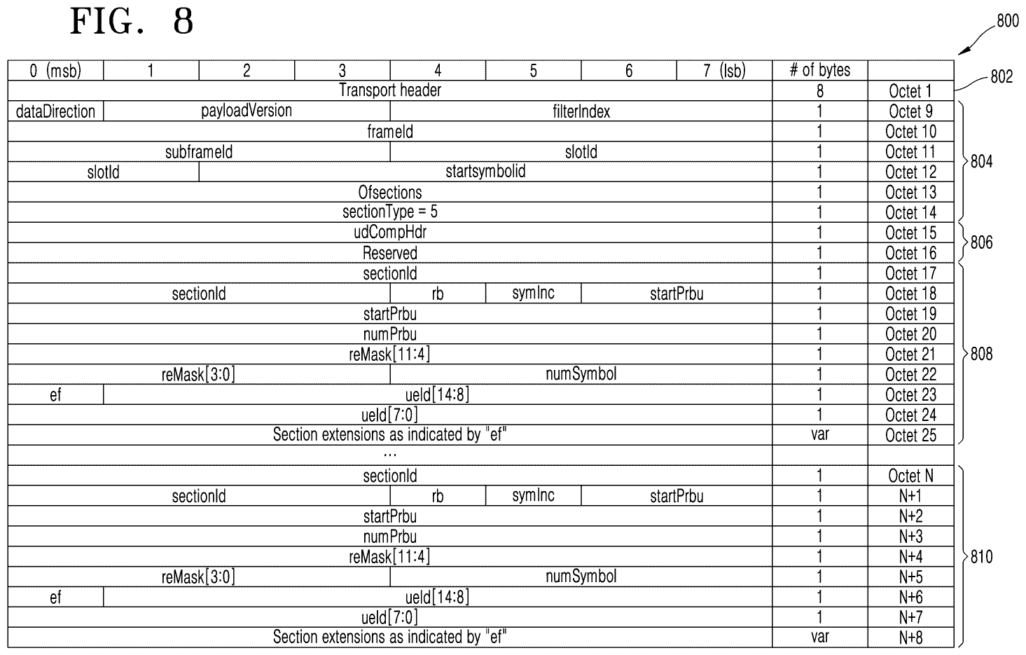

FIG. 8 illustrates a configuration of a section type, according to an embodiment of the present disclosure.

Referring to FIG. 8, a C-plane message 800 may include a transport header 802, a common header 804 (or a wireless application header or a timing header), a udCompHdr field 806, first section header 808, and second section header 810. In an embodiment, the C-plane message 800 may be a control message of section type 5. For example, the C-plane message 800 may convey UE scheduling information.

The transport header 802 may be included in an Ethernet payload and may describe how to process application data in the control plane and/or the user plane. The transport header 802 may be eight (8) bytes long and may provide basic data routing capabilities including a data flow type description, a transmission and reception port identifier, the ability to support concatenation of multiple applications in a single Ethernet packet, and sequence numbering. In an embodiment, when following the O-RAN standard, the transport header 802 may be, for example, an eCPRI transport header or an IEEE 1914.3 transport header. The eCPRI header may include at least some of the following parameters.
ecpriVersion (4 bits): 0001b (default). This parameter may indicate the eCPRI protocol version.
ecpriReserved (3 bits): 000b (default). This parameter may be reserved for future use of eCPRI.
ecpriConcatenation (1 bit): 0b (default). This parameter may indicate that eCPRI concatenation is in use (allowing multiple eCPRI messages in a single Ethernet payload).

ecpriMessage (1 byte): Message type. This parameter may indicate the type of a service that the message type conveys.
ecpriPayload (2 bytes): Payload size in bytes. This parameter is the byte size of a payload portion of the corresponding eCPRI message. This parameter may not include padding bytes following the eCPRI message. The supported maximum payload size may be 216-1, but the actual size may be further limited according to the underlying transport network.
ecpriRtcid/ecpriPcid (real-time control data/IQ data transfer message series identifier) (2 bytes): This parameter may indicate an extended antenna-carrier identifier (eAxC ID) and may identify a particular data flow associated with each C-plane (ecpriRtcid) or U-plane (ecpriPcid) message. This parameter may be similar to the “AxC” (antenna-carrier) value of CRPI, and therefore, may be designated here as “eAxC” (where “e” indicates “extended” to accommodate multiple bands and multiple component carriers). Multiple O-DU processors may contribute to a single eAxC.
ecpriSeqid (2 bytes): This parameter may provide unique message identification and ordering at two different levels. The first octet of the parameter may be a sequence ID used to identify the message order in the eAxC message stream. The second octet of the parameter may be a subsequence ID used to verify the order and implement reordering when a wireless transport level (e.g., eCPRI or IEEE-1914.3) fragmentation occurs.

Additionally or alternatively, an IEEE 1914.3 transport header may be used. The IEEE 1914.3 transport header may include at least some of the following parameters.
RoEsubType (1 byte): This field may indicate the payload type within the scope of the Radio over Ethernet Encapsulations and Mappings (RoE) subtype of the IEEE 1914.3 standard.
RoEflowId (1 byte): This field may identify a particular flow between the end-points. RoEflowID and 0xFF may be reserved for an RoE control packet. In an embodiment, the transport header 802 may not use this field.
RoElength (2 bytes): This field may be the byte size of a payload portion of the message. The payload length field value may be the total number of octets following the O-RAN common header. This field may not include the Ethernet FCS or subsequent bytes.
RoEorderInfo (4 bytes): This field may include ordering information. For example, this field may include DU_Port_ID (used to differentiate processing units (e.g., different baseband cards) in the DU), BandSector_ID (aggregated cell identifier, distinguishing bands and sectors supported by the O-RU), CC_ID (distinguishing component carriers supported by the O-RU), RU_Port_ID (used to differentiate spatial streams or beams on the O-RU), Sequence_ID (unique message sequence), E_Bit (marks the last message pertaining to the section), and/or Subsequence_ID (unique message order sub-sequence).

The common header 804 may include at least some of the following fields.
dataDirection (data direction (gNB Transmit Tx/Rx): 1 bit. This parameter may indicate the gNB data direction. This parameter may be used in combination with eAxC_ID to identify to or from which O-RU low level endpoint the C-plane/U-plane message is targeted or originated.
payloadVersion (payload version): 3 bits: set to value=1 (first protocol version for payload and time reference format). This parameter may indicate the payload protocol version valid for the following information elements (IEs) in the application layer.
filterIndex (filter index): 4 bits. This parameter may indicate an index to the channel filter to be used between IQ data and air interface, both in DL and UL.
frameId (frame identifier): 8 bits. This parameter may be a counter for 10 millisecond (ms) frames (e.g., a wrapping period 2.56 seconds) The value of the parameter frameId may be set to frame number modulo 256 (e.g., frameId=frame number mod 256).
subframeId (subframe identifier): 4 bits. This parameter may be a counter for 1 ms subframes within a 10 ms frame.
slotId (slot identifier): 6 bits. This parameter may be the slot number within a 1 ms subframe.
startSymbolId (start symbol identifier): 6 bits. This parameter may identify the symbol number (within a slot) of the earliest symbol, to which the information of the C-plane message 800 may be applicable.
numberOfsections (number of sections): 8 bits. This parameter may indicate the number of data section descriptions (e.g., separate citations of section ID even for multiple citations of the same sectionId) included in the C-plane message 800.
sectionType (Section Type): 8 bits: This parameter may determine the characteristics of U-plane (C-plane) data to be transmitted and/or received from a beam with one pattern ID.

The udCompHdr field 806 may include at least some of the following fields. In an embodiment, the udCompHdr field 806 may be included in the common header 804.
udCompHdr (user data compression header): 8 bits. The udCompHdr information may be provided on the U-plane, instructing the O-RU (on DL) and O-DU (on UL) how to interpret and/or decompress the received U-plane data. For UL U-plane data compression, the O-DU may instruct the O-RU via udCompHdr in a U-plane message.
Reserved (reserved for future use): 8 bits.

In an embodiment, each of the first and second section headers 808 and 810 may include at least some of the following fields. For example, each of the first and second section headers 808 and 810 may include any combination of the following fields, and the value of each field may be different for each section header.
sectionId (section identifier): 12 bits. When C-plane and U-plane coupling via sectionId is used, this parameter may identify individual data sections that may be described by data section descriptions within the C-plane message. The sectionId may map U-plane data sections to the corresponding U-plane message (and Section Types) associated with the data.
rb (resource block identifier): 1 bit. This parameter may indicate whether every RB is used or every other RB is used.
symInc (symbol number increment command): 1 bit. This parameter may indicate which symbol number is relevant to a given section description. The same value may be used for each section in the message as long as symInc is zero (0). When symInc is one (1), the maintained symbol number may be increased to the next symbol, and the new symbol number may be used for the section and each subsequent section until the symInc bit is again detected to be one (1).
startPrbc (starting PRB of data section description): 10 bits. This parameter may convey the first (lowest frequency) PRB described by the section description.
numPrbc (number of contiguous PRBs per data section description): 8 bits. This parameter may convey the number of PRBs described by the section description.
reMask (resource element mask): 12 bits. This parameter may indicate the resource element (RE) mask within a PRB.
numSymbol (number of symbols): 4 bits. This parameter may indicate the number of PRACH symbols or the number of PRACH symbols in a PRACH occasion in the case of PRACH or the number of PRACH symbols in a NPRACH symbol group in the case of NPRACH, to which the section control is applicable.
ef (extension flag): 1 bit. This parameter may indicate whether this section has any section extensions included in the message.
ueId field: 15 bits. This parameter may be used to support channel-information-based beamforming in Section Type 5.

In an embodiment, the first or second section header 808 or 810 may include an extension flag. The presence of the extension flag may indicate that a section extension is present following the header. For example, when the field ef of the first section header 808 is 1, the section extensions indicated by ef may follow the first section header 808.

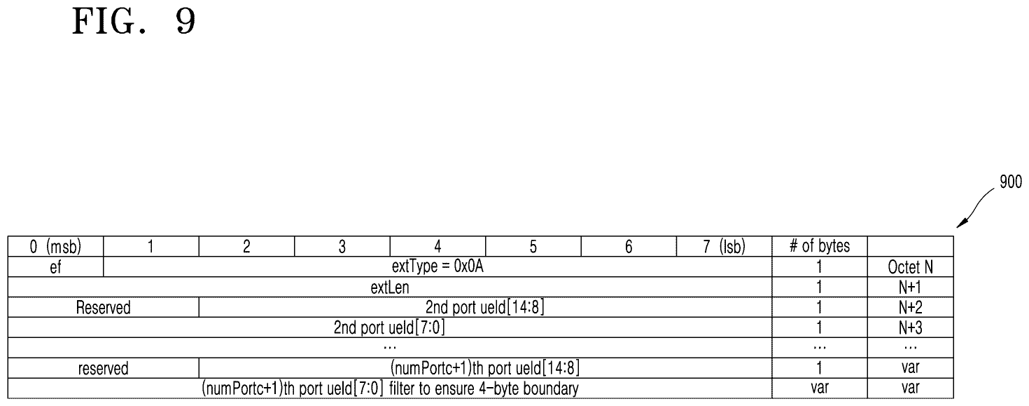

FIG. 9 illustrates a configuration of a section extension, according to an embodiment of the present disclosure.

Referring to FIG. 9, a section extension field 900 may include at least some of ef, extType, extLen, or second port ueId to (numPort+1)th port ueId. In an embodiment, the section extension field 900 may correspond to section extension 10 according to the O-RAN standard. For example, the section extension field 900 may include information for grouping multiple ports or multi-UE scheduling information. In an embodiment, the section extension field 900 may be applied to C-plane messages of section types 1, 3, and 5. However, the present disclosure is not limited thereto. For example, the section extension field 900 may be included in the C-plane message 800 of FIG. 8. In an embodiment, the section extension field 900 may include beamId of each port instead of ueId of each port.

ef may indicate that there is a section extension. extType may indicate the type of the section extension of the section extension field 900. extLen may indicate the length of the section extension (e.g., the length of the section extension field 900).

In an embodiment, the section extension field 900 may further include beamGroupType and numPortc fields. beamGroupType may indicate the type of beam grouping (e.g., common beam, beam matrix indication, beam vector listing, or beamId/ueId list with associated port-list index). In an embodiment, the value of beamGroupType may be 10b. However, the present disclosure is not limited thereto. numPorte may indicate the number of eAxC ports indicated by the section extension. In an embodiment, the beamGroupType field may follow the extLen field, and the numPorte field may follow the beamGroupType.

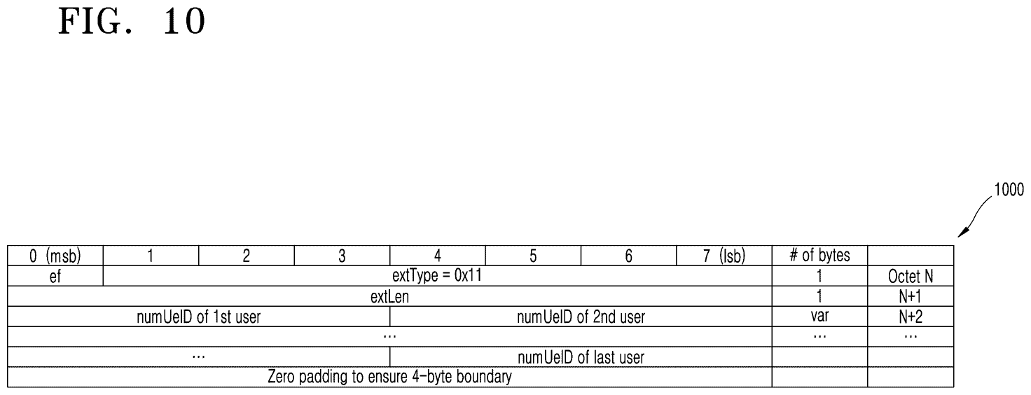

FIG. 10 illustrates a configuration of a section extension, according to an embodiment of the present disclosure.

Referring to FIG. 10, a section extension field 1000 may include at least some of ef, extType, extLen, or numUeID of each user. In an embodiment, the section extension field 1000 may correspond to section extension 17 according to the O-RAN standard. For example, the section extension field 900 may include an indication or information about a user port group. The section extension field 1000 may include information about the number of ueIds of users scheduled in the preceding section types and section extension messages. The user may have multiple ueIds (e.g., may have multiple channel information, for example, when the UE supports a TAS function for SRS transmission, the O-DU may obtain various channel information corresponding to each of the transmission antennas).

ef may indicate that there is a section extension. extType may indicate the type of the section extension of the section extension field 1000 (e.g., 0×11, or 17). extLen may indicate the length of the section extension (e.g., the length of the section extension field 1000). numUeID may indicate the number of ueIds per user.

In an embodiment, the ueId of each user may be sequentially assigned by using the three reserved bits of ueId[2:0]. Consequently, the maximum number of ueIds supported per user may be eight (8). Additionally or alternatively, the ueIds in which all three (3) reserved bits are 0 in the previous section extension (e.g., section extension 10) may be repeatedly configured as many times as the number of layers allocated to the user. Thus, the previous section type and extension message may implicitly provide the number of scheduled users (e.g., the number of different ueIds) and the number of layers for each user (e.g., the number of identical ueIds). The number of ueIds associated with each user may be provided in the section extension field 1000.

For example, a 15-bit ueId may include a TAS antenna identifier (or discriminator) of the corresponding user and identifiers (or discriminators) of different users. For example, three (3) consecutive least significant bits (LSBs) of the 15-bit ueId (e.g., ueId[2:0]) may identify a TAS antenna of the same user. For example, ueId[2:0] may include information about any one of the antennas of the terminal of the corresponding user (e.g., the user corresponding to the preceding ueId[14:3]). ueId[14:3] may be used to distinguish different users. For example, different users may have different ueId[14:3] values.

In an embodiment, the section extension field 1000 may be applied to the section extension field 900 of FIG. 9. For example, the section extension field 1000 may be included in the C-plane message 800 of FIG. 8 together with the section extension field 900 of FIG. 9.

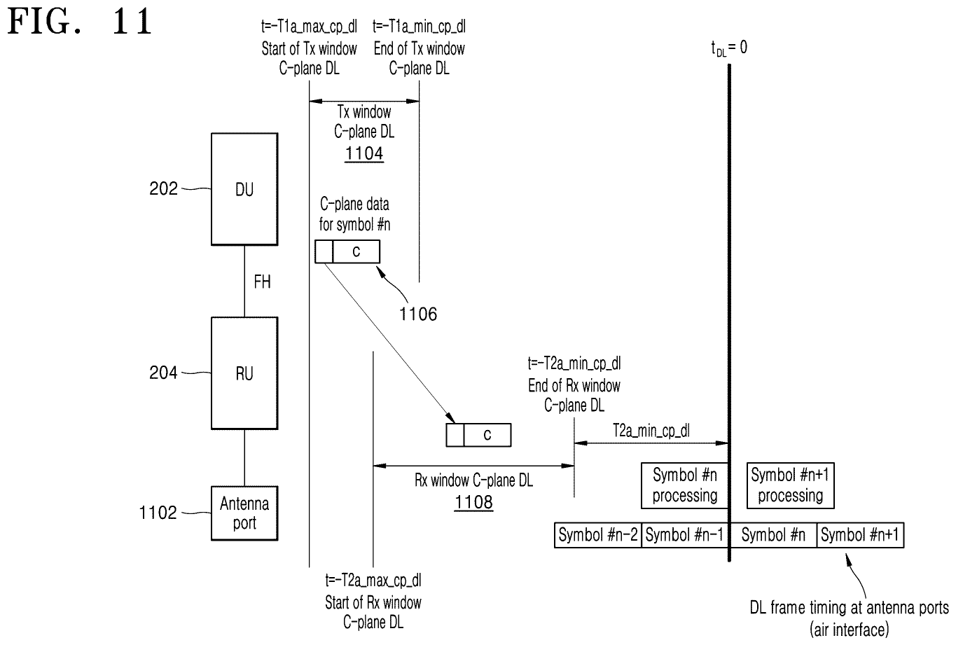

FIG. 11 illustrates a timing of downlink C-plane data transmission/reception between a DU and an RU, according to an embodiment of the present disclosure.

Referring to FIG. 11, the DU 202 and the first RU 204 may communicate by using a fronthaul interface FH. The first RU 204 may be connected to an antenna port 1102. The antenna port 1102 may include one or more antenna arrays for the base station 200 to communicate with a user terminal. For example, the antenna port 1102 may be included in a transceiver for communication between the base station 200 and the user terminal. In an embodiment, the antenna port 1102 may be included in the MMU 408 of the first RU 204.

The fronthaul interface FH may include a control plane and a user plane. The control plane may need to be used to process the corresponding U-plane packet. For example, C-plane data (or a C-plane message) 1106 for symbol #n may need to be transferred to the first RU 204 prior to processing symbol #n. As shown in FIG. 11, a reference point (e.g., t_{dl}=0) may indicate the transmission of the earliest IQ sample (including CP) in the time domain within a symbol (e.g., symbol #n) that may be generated from the IQ data received in a U-plane message specific to a symbol identified by symbolId.

For downlink, a C-plane message with instructions for transmission of a downlink radio signal, for example, a C-plane message of a data flow with dataDirection=1, may be transmitted from the DU 202 to the first RU 204 and may refer to one or more symbols. The transmission and reception window for a downlink C-plane message referencing multiple symbols may be relative to the start of the earliest symbol referenced by the message. For example, the C-plane message 1106 may be transmitted from the DU 202 to the first RU 204 during a C-plane downlink transmission window 1104. In an embodiment, the C-plane message 1106 may be configured in a similar way to the C-plane message 800 of FIG. 8 and may include the section extension field 900 of FIG. 9 and the section extension field 1000 of FIG. 10.

As shown in FIG. 11, the C-plane downlink transmission window 1104 may correspond to (or may be included in) a time interval between t=−T1a_max_cp_dl and t=−T1a_min_cp_dl. T1a_max_cp_dl may be a parameter indicating the start of the C-plane downlink transmission window. T1a_min_cp_dl may be a parameter indicating the end of the C-plane downlink transmission window. The C-plane message 1106 may be received by the first RU 204 during a C-plane downlink reception window 1108. As shown in FIG. 11, the C-plane downlink reception window 1108 may correspond to (or may be included in) a time interval between t=−T2a_max_cp_dl and t=−T2a_min_cp_dl. T2a_max_cp_dl may be a parameter indicating the start of the C-plane downlink reception window. T2a_min_cp_dl may be a parameter indicating the end of the C-plane downlink reception window.

Based on the received C-plane message 1106, the first RU 204 may process information included in a symbol corresponding to the C-plane message 1106. The first RU 204 may need to process data (e.g., IQ sample) for symbol #n during a predefined period T2a_min_cp_dl. T2a_min_cp_dl may be a parameter indicating a minimum RU data processing delay between receiving a downlink real-time C-plane message through the fronthaul interface and transmitting the corresponding first IQ sample from the antenna. At a reference point, the first RU 204 may transmit a frame corresponding to symbol #n by using the antenna port 1102.

As described above, in order to transmit a frame corresponding to symbol #n at the reference point by using the antenna port 1102, a C-plane message of a section type to be transmitted for each symbol may be transferred to the first RU 204 before the corresponding symbol is processed, and the first RU 204 may need to process data for the corresponding symbol during the interval T2a_min_cp_dl. The data processing for symbol #n may include channel information-based beamforming. For example, during the interval T2a_min_cp_dl, based on the information included in the C-plane message 1106 (e.g., numUeID of each user and/or ueId of each port) and the channel information, the first RU 204 may need to complete the SVD processing and SVD-based beamforming described above with reference to FIGS. 5 to 7. The parameter T2a_min_cp_dl may be value with a range in the hundreds of microseconds (μs) (e.g., 250 μs). Thus, despite the complexity of an SVD operation, SVD-based beamforming may take a relatively short time, thus increasing the complexity of the hardware for SVD processing.

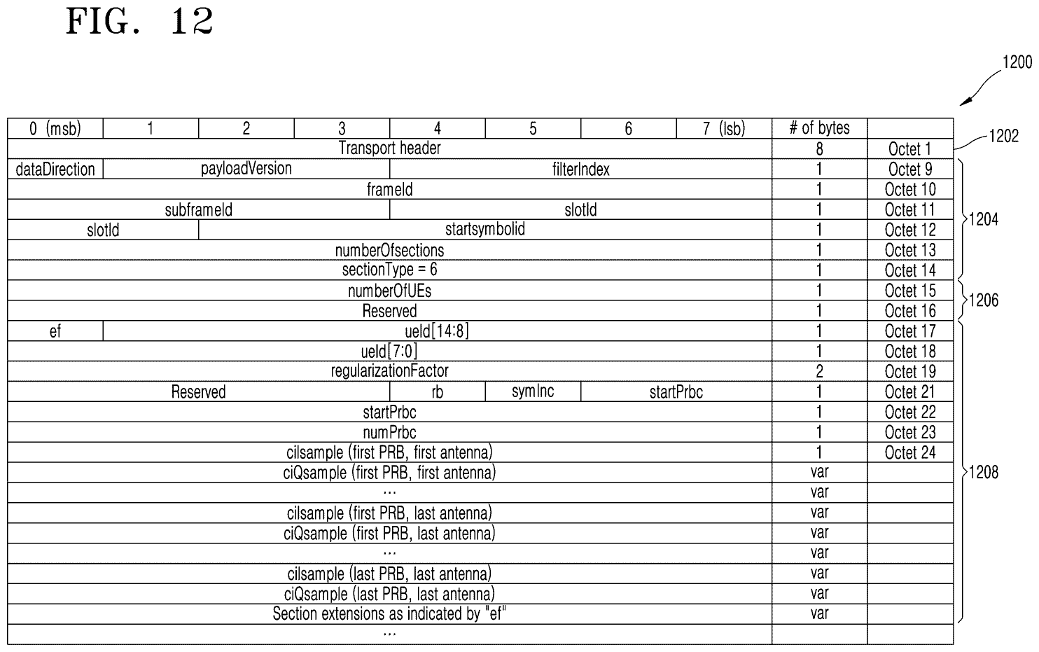

FIG. 12 illustrates a configuration of a section type, according to an embodiment of the present disclosure.

Referring to FIG. 12, a C-plane message 1200 may include a transport header 1202, a common header 1204 (or a wireless application header or a timing header), a numberOfUEs field 1206, and a section header 1208. In an embodiment, the C-plane message 1200 may be a control message of section type 6 of the O-RAN standard. For example, the C-plane message 1200 may convey channel information (e.g., channel information per ueId).

The transport header 1202 may be configured in a similar way to the transport header 802 of FIG. 8. The common header 1204 may include dataDirection, payloadVersion, filterIndex, frameId, subframeId, slotID, startSymbolId, numberOfsections, and sectionType. Description of the parameters common to the common header 804 of FIG. 8 among the fields of the common header 1204 may be omitted for the sake of brevity.

The numberOfUEs field 1206 (8 bits) may indicate the number of UE-specific channel information data sets. The numberOfUEs field 1206 may indicate the number of UEs (for which channel information is provided) included in the C-plane message 1200. The numberOfUEs field 1206 may further include 8-bit reserved fields.

In an embodiment, a ciCompHdr (channel information compression header) field may be added following the numberOfUEs field 1206. The ciCompHdr field (8 bits) may correspond to a channel information compression header. The ciCompHdr field may indicate a compression method and an IQ bit width for the channel information. For example, the ciCompHdr field may include subfields ciIqWidth, ciCompMeth, and ciCompOpt. ciIqWidth may indicate the bit width of each I and each Q. ciCompMeth may indicate the compression method (e.g., no compression, block floating point, block scaling, or μ-law method). ciCompOpt may indicate the compression option (e.g., compression per UE or compression per PRB).

The section header 1208 may include at least some of the following fields. The description of fields (parameters) common to the first and second section headers 808 and 810 of FIG. 8 among the following fields may be omitted.
ef (extension flag): 1 bit.
ueId field: 15 bits. This parameter may support channel-information-based beamforming (CIBF) by providing a logical identifier for the channel information set associated with a spatial stream of the UE transported through the C-plane message 1200.
regularizationFactor (regularization factor used for minimum mean square error (MMSE) reception): 16 bits. This parameter may provide a signed value to support an MMSE operation within the O-RU when beamforming weights are supported in the O-RU.
reserved (reserved for the future): 4 bits.
rb (resource block identifier): 1 bit. For example, this may be set to value=0.
symInc (symbol number increment command): 1 bit.
startPrbc (starting PRB of data section description): 10 bits.
numPrbc (number of contiguous PRBs per data section description): 8 bits.
ciIsample (channel information value, in-phase sample): 1 to 16 bits.
ciQsample (channel information value, quadrature sample): 1 to 16 bits. The ciIsample and ciQsample values may be the channel information complex values relayed from the DU 202 to the first RU 204. In an embodiment, values for the first Prbc from the first antenna to the last antenna may be transmitted, and subsequently, values for the second Prbc from the first antenna to the last antenna may be transmitted, which may be repeated until values for the last Prbc (PRB collection) from the first antenna to the last antenna have been transmitted. However, the present disclosure is not limited to the illustrated embodiment. For example, these values may be transmitted for each PRB group (e.g., from the first antenna to the last antenna for the first PRB group, and subsequently, from the first antenna to the last antenna for the second PRB group). Each PRB group for one antenna may include a ciIsample or a ciQsample pair. Padding (set to 0) bits may be inserted after the last Q value (e.g., the last ciQsample value).

In an embodiment, the section header 1208 may further include ciCompParam. ciCompParam may be a channel information compression parameter and may be zero (0) bits or eight (8) bits. This parameter may be applied to a compression method specified by the associated ciCompMeth value. When ciCompOpt (a sub-field of ciCompHdr) is zero (0), this parameter may be applied to the next vector of ciIsample, ciQsample for all PRBs of a particular UE. When ciCompOpt (a sub-field of ciCompHdr) is one (1), this parameter may be applied to the next vector of ciIsample, ciQsample for all antennas of a particular PRB. In an embodiment, the section header 1208 may further include ciCompParam for the first PRB of the corresponding UE or for all PRBs. ciCompParam may be inserted between numPrbc and the first ciIsample value.

In an embodiment, the C-plane message 1200 may further include one or more repeated section headers of a similar configuration to the section header 1208. For example, the C-plane message 1200 may include a plurality of section headers indicating channel information of a plurality of UEs (or a plurality of ueIds). Each section header may include the ueId of the corresponding UE (or the corresponding ueId) and the channel information values (e.g., a pair (pairs) of ciIsample and ciQsample).

The configuration of the C-plane message 1200 illustrated in FIG. 12 is just an example, and the configuration of the C-plane message 1200 is not limited to the configuration illustrated in FIG. 12. In an embodiment, some configurations of the C-plane message 1200 of FIG. 12 may be added, deleted, or modified.

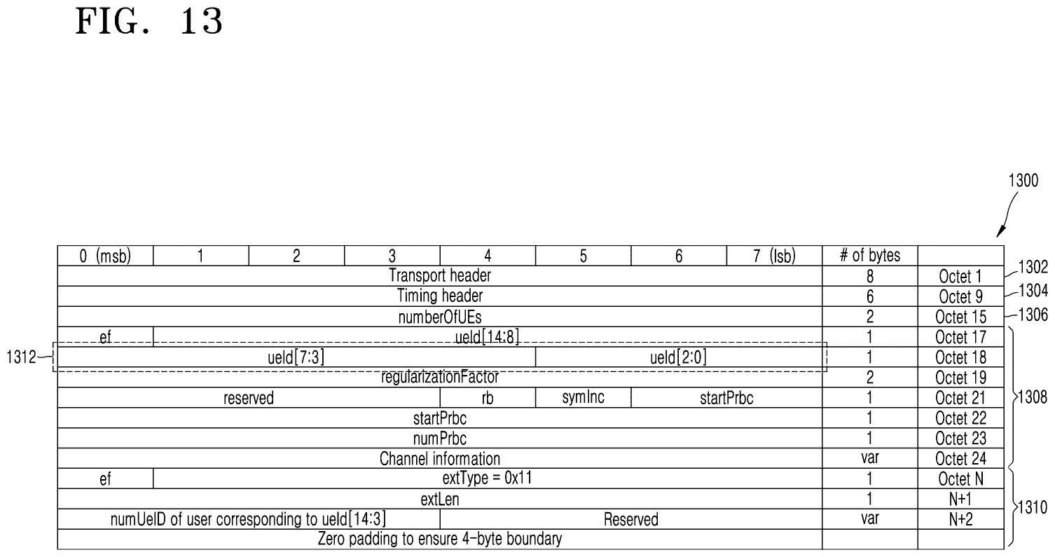

FIG. 13 illustrates a configuration of a section type including a section extension, according to an embodiment of the present disclosure.

Referring to FIG. 13, a C-plane message 1300 may include a transport header 1302, a timing header 1304, a numberOfUEs field 1306, a section header 1308, and a section extension field 1310. In an embodiment, the C-plane message 1300 may be a control message of section type 6 of the O-RAN standard, and the section extension field 1310 may be a section extension field of section extension 17 of the O-RAN standard. In other words, the C-plane message of section type 6 may include section extension 17. For example, the C-plane message 1300 may include information about the number of ueIds of users together with channel information (e.g., channel information per ueId). Accordingly, based on the C-plane message 1300, the first RU 204 may identify that the UE 502 supports TAS and may identify the number of antennas used for TAS.

In an embodiment, the first RU 204 may report its capability of supporting section extension 17 in section type 6 to the DU 202 through an M-plane message. Based on the M-plane message from the first RU 204, the DU 202 may identify that the first RU 204 supports the C-plane message 1300. The DU 202 may identify whether channel information is in the DU 202. Based on identifying that the first RU 204 supports the C-plane message 1300 and identifying that channel information is in the DU 202, the DU 202 may generate a C-plane message 1300 including a section header 1308 including ueId and a section extension field 1310 including numUeID.

The transport header 1302 may be configured in a similar way to the transport header 1202 of FIG. 12. The timing header 1304 may be configured in a similar way to the common header 1204 of FIG. 12. The numberOfUEs field 1306 may be configured in a similar way to the numberOfUEs field 1206 of FIG. 12. The section header 1308 may be configured in a similar way to the section header 1208 of FIG. 12. For example, the section header 1308 may include at least some of the fields (parameters) included in the section header 1208. The channel information field included in the section header 1308 may include channel information corresponding to ueId[14:0] of the section header 1308. Descriptions of the common fields (or parameters) between the C-plane message 1300 and the C-plane message 1200 may be omitted for the sake of brevity.

Continuing to refer to FIG. 13, the section header 1308 may include a ueId field 1312. As described above with reference to FIG. 10, three (3) consecutive least significant bits (LSBs) of the 15-bit ueId (e.g., ueId[2:0]) may identify a TAS antenna of the same user. The other bits (e.g., ueId[14:3]) may be used to distinguish different users. For example, ueId[2:0] of the ueId field 1312 may indicate any one of the antennas of the user. ueId[14:3] may indicate the user associated with the section header 1308.

The C-plane message 1300 of FIG. 13 may include a section extension field 1310. The section extension field 1310 may be configured in a similar way to the section extension field 1000 of FIG. 10. For example, the section extension field 1310 may include an ef field indicating that there is a section extension, an extType field indicating that the section extension type is 17, an extLen field indicating the length of the section extension field 1310, and a field indicating the numUeID of a scheduled user (e.g., a user corresponding to ueId[14:3]) in the section header 1308 preceding the section extension field 1310.

As described above with reference to FIGS. 5 and 6, in order to transmit a signal to the UE 502, the first RU 204 of the base station 200 may perform SVD beamforming by using channel information associated with each antenna of the UE 502. For example, the first RU 204 may perform SVD processing (or operation) based on at least some of the ueId of section type 6, the channel information of section type 6, and the numUeID of section extension 17. In response to receiving the C-plane message 1300, the first RU 204 may start SVD processing based on the C-plane message 1300. For example, the first RU 204 may identify the number of channel information for each user based on numUeID and identify antenna-by-antenna channel information for the corresponding user based on ueId. The first RU 204 may perform SVD processing based on the antenna-by-antenna channel information.

The C-plane message of section type 6 (e.g., the C-plane message 1200 or the C-plane message 1300) may be a non-delay managed C-plane message. For example, the DU 202 may transmit a C-plane message of section type 6 including per-UE channel information to the first RU 204 at a period equal to or longer than a slot. The transmission/reception window constraints may not be applied to the C-plane message of section type 6. For example, the C-plane message of section type 6 may be transmitted/received regardless of a transmission/reception window for the control plane (e.g., the windows 1104 and 1108 of FIG. 11). The C-plane message of section type 6 may not be transmitted on a symbol-by-symbol or slot-by-slot basis. For example, the C-plane message of section type 6 may be transmitted at a period equal to or longer than a slot. Thus, the processing delay allowed for the first RU 204 to perform beamforming based on the information included in the C-plane message of section type 6 with section extension 17 may be several milliseconds. This may be in contrast to the processing delay for beamforming based on the C-plane message of section type 5 with section extension 17 being several hundred microseconds as described above with reference to FIG. 11. As a result, the first RU 204 may secure a longer time for SVD processing, and thus, the complexity of hardware implementation for SVD processing in the first RU 204 may be reduced by comparison.

In an embodiment, the section extension field 1310 may be added for all ueId[2:0]. For example, in the C-plane message of section type 6, each section header may include section extension 17 regardless of ueId[2:0] in the section header. Thus, for each user, the C-plane message of section type 6 may include as many section extension 17 fields as the number of ueIds of each user. Tables 2 to 4 below illustrate the ueId values of the section header and the numUeID values of the section extension 17 field in the section type 6 C-plane messages for user 0, user 1, and user 2, respectively. The ueId described in Tables 2 to 4 may indicate the value of ueID[4:0] of each user.

TABLE 2

| | ueId of section type 6 | numUeID of section |
|---|---|---|
| user 0 | C-plane message | extension 17 field |
| ueID = 01000b | ueID = 01000b | numUeID = 8 |
| ueID = 01001b | ueID = 01001b | numUeID = 8 |
| ueID = 01010b | ueID = 01010b | numUeID = 8 |
| ueID = 01011b | ueID = 01011b | numUeID = 8 |
| ueID = 01100b | ueID = 01100b | numUeID = 8 |
| ueID = 01101b | ueID = 01101b | numUeID = 8 |
| ueID = 01110b | ueID = 01110b | numUeID = 8 |
| ueID = 01111b | ueID = 01111b | numUeID = 8 |

Referring to Table 2, ueId[2:0] of user 0 may be any one of eight (8) values 000b to 111b. Each of the eight (8) ueId[2:0] values may correspond to any one of the antennas of user 0, and thus, the antennas of user 0 may be identified based on ueId[2:0] of user 0. Because the ueIDs in Table 2 are for user 0, the values of ueId[4:3] may be equal to each other. Continuing to refer to Table 2, regardless of the values of ueId[2:0], section extension 17 may follow the section header for each ueId. Because user 0 has eight (8) ueIds, section extension 17 for each section header may include numUeID with a value of eight (8).

TABLE 3

| | ueId of section type 6 | numUeID of section |
|---|---|---|
| user 1 | C-plane message | extension 17 field |
| ueID = 10000b | ueID = 10000b | numUeID = 4 |
| ueID = 10001b | ueID = 10001b | numUeID = 4 |
| ueID = 10010b | ueID = 10010b | numUeID = 4 |
| ueID = 10011b | ueID = 10011b | numUeID = 4 |

Referring to Table 3, ueId[2:0] of user 1 may be any one of four (4) values 000b to 011b. Each of the four (4) ueId[2:0] values may correspond to any one of the antennas of user 1, and thus, the antennas of user 1 may be identified based on ueId[2:0] of user 1. Because the ueIDs in Table 3 are for user 1, the values of ueId[4:3] may be equal to each other. In Table 3, regardless of the values of ueId[2:0], section extension 17 may follow the section header for each ueId. Because user 1 has four (4) ueIds, section extension 17 for each section header may include numUeID with a value of four (4).

TABLE 4

| | ueId of section type 6 | numUeID of section |
|---|---|---|
| user 2 | C-plane message | extension 17 field |
| ueID = 11000b | ueID = 11000b | numUeID = 2 |
| ueID = 11001b | ueID = 11001b | numUeID = 2 |

Referring to Table 4, ueId[2:0] of user 2 may be 000b or 001b. Each of the two (2) ueId[2:0] values may correspond to any one of the antennas of user 2, and thus, the antennas of user 2 may be identified based on ueId[2:0] of user 2. Because the ueIDs in Table 4 are for user 2, the values of ueId[4:3] may be equal to each other. In Table 4, regardless of the values of ueId[2:0], section extension 17 may follow the section header for each ueId. Because user 2 has two (2) ueIds, section extension 17 for each section header may include numUeID with a value of two (2).

In an embodiment, the section extension field 1310 may be added only for one or more particular ueId[2:0]. Based on the ueId[2:0] value included in the section header of each section type 6, section extension 17 may be added only for some section headers of section types 6. For example, in the C-plane message of section type 6, section extension 17 may be added only for a section header (section headers) whose ueId[2:0] value is one or more particular values. For example, section extension 17 may be added only for a section header with ueId[2:0]=0. Accordingly, when a section type 6 command is invoked more than once to convey channel information for the user (e.g., more than one channel information), the number of ueIds may be provided once only in a case where ueId[2:0] is zero (0) and the DU 202 may append section extension 17 together with the first section description in the section type 6 command for the user. Tables 5 to 7 below illustrate the ueId values of the section header and the numUeID values of the section extension 17 field in the section type 6 C-plane messages for user 0, user 1, and user 2, respectively. The ueId described in Tables 5 to 7 may indicate the value of ueID[4:0] of each user.

TABLE 5

| | ueId of section type 6 | numUeID of section |
|---|---|---|
| user 0 | C-plane message | extension 17 field |
| ueID = 01000b | ueID = 01000b | numUeID = 8 |
| ueID = 01001b | ueID = 01001b | — |
| ueID = 01010b | ueID = 01010b | — |
| ueID = 01011b | ueID = 01011b | — |
| ueID = 01100b | ueID = 01100b | — |
| ueID = 01101b | ueID = 01101b | — |
| ueID = 01110b | ueID = 01110b | — |
| ueID = 01111b | ueID = 01111b | — |

Referring to Table 5, ueId[2:0] of user 0 may be any one of eight (8) values 000b to 111b. In contrast to Table 2, in Table 5, section extension 17 may follow only the section header of section type 6 including ueId[2:0]=0 (e.g., ueId=01000b). Section extension 17 may not be added for the other section headers of section type 6 associated with user 0.

TABLE 6

| | ueId of section type 6 | numUeID of section |
|---|---|---|
| user 1 | C-plane message | extension 17 field |
| ueID = 10000b | ueID = 10000b | numUeID = 4 |
| ueID = 10001b | ueID = 10001b | — |
| ueID = 10010b | ueID = 10010b | — |
| ueID = 10011b | ueID = 10011b | — |

Referring to Table 6, ueId[2:0] of user 1 may be any one of four (4) values 000b to 011b. In contrast to Table 3, in Table 6, section extension 17 may follow only the section header of section type 6 including ueId[2:0]=0 (e.g., ueId=10000b). Section extension 17 may not be added for the other section headers of section type 6 associated with user 1.

TABLE 7

| | ueId of section type 6 | numUeID of section |
|---|---|---|
| user 2 | C-plane message | extension 17 field |
| ueID = 11000b | ueID = 11000b | numUeID = 2 |
| ueID = 11001b | ueID = 11001b | — |

Referring to Table 7, ueId[2:0] of user 2 may be any one of values 000b or 001b. In contrast to Table 4, in Table 7, section extension 17 may follow only the section header of section type 6 including ueId[2:0]=0 (e.g., ueId=01000b). Section extension 17 may not be added for the other section headers of section type 6 associated with user 2.

Additionally or alternatively, section extension 17 may be added only for a section header (section headers) where the value of ueId[2:0] is an even number, a section header (section headers) where the value of ueId[2:0] is an odd number, a section header (section headers) where the value of ueId[2:0] is a multiple of a particular natural number, a section header (section headers) where the value of ueId[2:0] is a prime number, and/or a value equal to numUeID divided by 2 (or rounded off/rounded up below the decimal point/truncated below the decimal point). However, the present disclosure is not limited thereto.

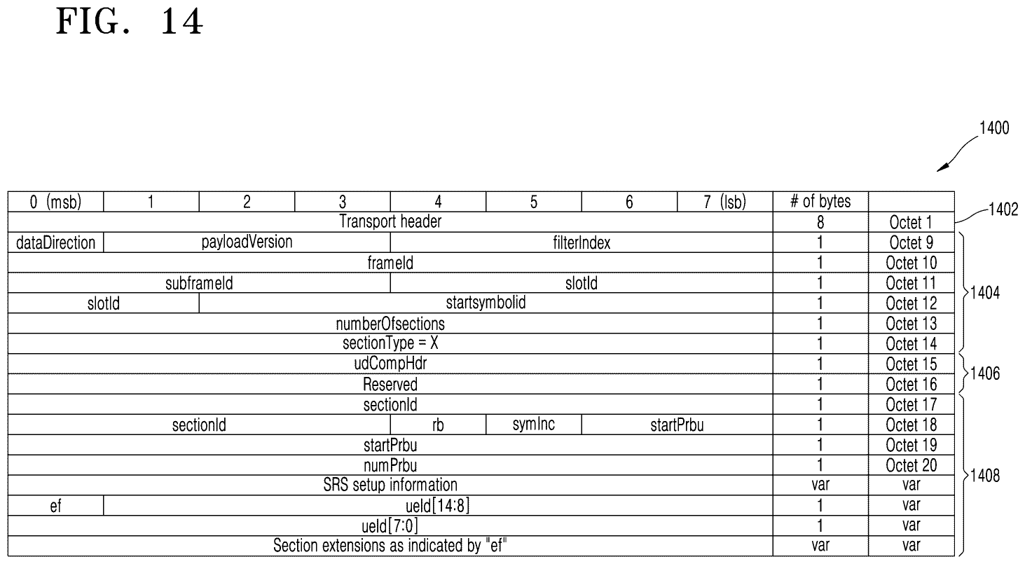

FIG. 14 illustrates a configuration of a section type, according to an embodiment of the present disclosure.

Referring to FIG. 14, a C-plane message 1400 may include a transport header 1402, a common header 1404 (or a wireless application header or a timing header), a udCompHdr field 1406, and a section header 1408. In the illustrated embodiment, the section type of the C-plane message 1400 may be ‘X’ (where ‘X’ is a positive integer greater than zero (0)). Hereinafter, the C-plane message 1400 may be referred to as a ‘C-plane message of section type X’ or a ‘section type X C-plane message’. The section header 1408 may be referred to as a ‘section header of section type X’ or a ‘section type X section header’.

In an embodiment, the C-plane message 1400 may be a ueId-by-ueId C-plane message that indicates a channel estimation operation to the first RU 204. For example, the C-plane message 1400 may include information for directly or indirectly commanding (or instructing or requesting) to perform channel estimation. In some embodiments, a channel estimation function may be allocated to the first RU 204 rather than the DU 202, and accordingly, the DU 202 may command the first RU 204 to perform channel estimation through the C-plane message 1400. In response to the C-plane message 1400, the MMU 408 of the first RU 204 may perform channel estimation and perform SVD beamforming based on the obtained channel information. In an embodiment, the C-plane message 1400 may be transmitted from the DU 202 to the first RU 204 according to the SRS period.

The transport header 1402 may be configured in a similar way to the transport header 802 of FIG. 8. The common header 1404 may be configured in a similar way to the common header 804 of FIG. 8. Description of the parameters common to the common header 804 of FIG. 8 among the fields of the common header 1404 may be omitted for the sake of brevity. The udCompHdr field 1406 may be configured in a similar way to the udCompHdr field 806 of FIG. 8. Descriptions of the parameters common to the udCompHdr field 806 of FIG. 8 among the udCompHdr field 1406 may be omitted for the sake of brevity.

The section header 1408 may include at least some of the following fields. Descriptions of the fields (parameters) common to the first and second section headers 808 and 810 of FIG. 8 or the fields (parameters) common to the section header 1208 of FIG. 12 among the following fields may be omitted.
sectionId (section identifier): 12 bits.
rb (resource block identifier): 1 bit.
symInc (symbol number increment command): 1 bit.
startPrbc (starting PRB of data section description): 10 bits.
numPrbc (number of contiguous PRBs per data section description): 8 bits.
SRS setup information: 8 bits. The SRS setup (configurationsetup) information may include information necessary to support SRS-based channel estimation, such as SRS resource configuration (e.g., SRS transmission period, time slot position, or frequency resource), SRS transmission power and beamforming information, antenna configuration information of the UE, or coding and compression configuration of the SRS signal.
ef (extension flag): 1 bit.
ueId field: 15 bits.

The configuration of the C-plane message 1400 illustrated in FIG. 14 is just an

example, and the configuration of the C-plane message 1400 is not limited to the configuration illustrated in FIG. 14. In an embodiment, some configurations of the C-plane message 1400 of FIG. 14 may be added, deleted, or modified.

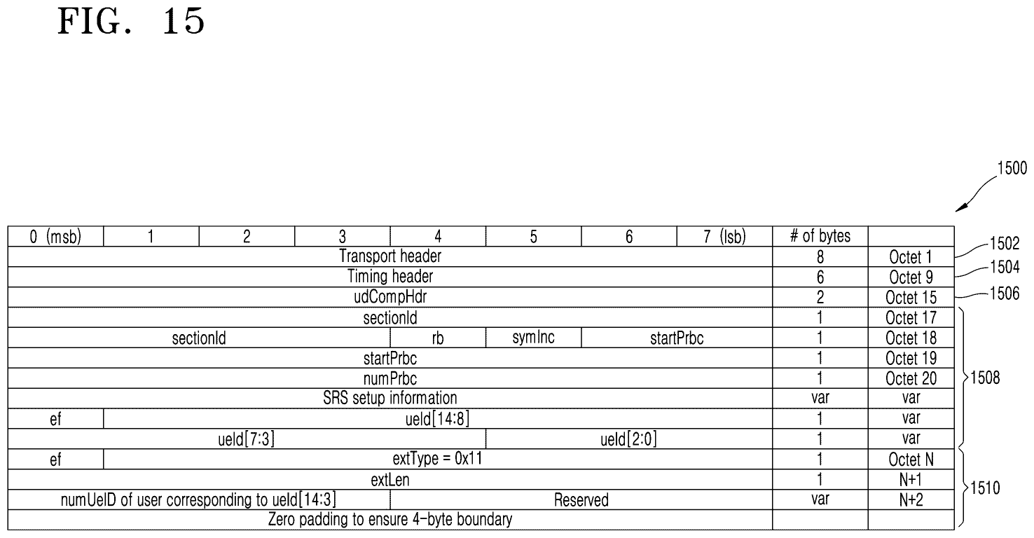

FIG. 15 illustrates a configuration of a section type including a section extension, according to an embodiment of the present disclosure.

Referring to FIG. 15, a C-plane message 1500 may include a transport header 1502, a timing header 1504, a udCompHdr field 1506, a section header 1508, and a section extension field 1510. In an embodiment, the C-plane message 1500 may correspond to a message in which the section extension field 1510 is added to the C-plane message 1400 of FIG. 14. The section extension field 1510 may be a section extension field of section extension 17 of the O-RAN standard. For example, the C-plane message 1500 may include information about the number of ueIds of users together with a command for SRS-based channel estimation. Accordingly, based on the C-plane message 1500, the first RU 204 may identify that the UE 502 supports TAS and may identify the number of antennas used for TAS.

In an embodiment, the first RU 204 may report its capability of supporting section extension 17 in section type X to the DU 202 through an M-plane message. Based on the M-plane message from the first RU 204, the DU 202 may identify that the first RU 204 supports the C-plane message 1500. The DU 202 may identify whether channel information is in the DU 202. Based on identifying that the first RU 204 supports the C-plane message 1500 and identifying that channel information is not in the DU 202, the DU 202 may generate a C-plane message 1500 including a section header 1508 including ueId and a section extension field 1510 including numUeID.

The transport header 1502 may be configured in a similar way to the transport header 1402 of FIG. 14. The timing header 1504 may be configured in a similar way to the common header 1404 of FIG. 14. The udCompHdr field 1506 may be configured in a similar way to the udCompHdr field 1406 of FIG. 14. The section header 1508 may be configured in a similar way to the section header 1408 of FIG. 14. For example, the section header 1508 may include at least some of the fields (parameters) included in the section header 1408. The SRS setup information field included in the section header 1508 may include SRS setup information corresponding to ueId[14:0] of the section header 1508. Descriptions of the common fields (or parameters) between the C-plane message 1500 and the C-plane message 1400 may be omitted for the sake of brevity.

In FIG. 15, the section header 1508 may include a ueId field. As described above with reference to FIGS. 10 and 13, three (3) consecutive least significant bits (LSBs) of the 15-bit ueId (e.g., ueId[2:0]) may identify a TAS antenna of the same user. The other bits (e.g., ueId[14:3]) may be used to distinguish different users. For example, ueId[2:0] of the ueId field may indicate any one of the antennas of the user. ueId[14:3] may indicate the user associated with the section header 1508.

The C-plane message 1500 of FIG. 15 may include a section extension field 1510. The section extension field 1510 may be configured in a similar way to the section extension field 1000 of FIG. 10 or the section extension field 1310 of FIG. 13. The section extension field 1510 may correspond to section extension 17. For example, the section extension field 1510 may include an ef field indicating that there is a section extension, an extType field indicating that the section extension type is 17, an extLen field indicating the length of the section extension field 1510, and a field indicating the numUeID of a scheduled user (e.g., a user corresponding to ueId[14:3]) in the section header 1508 preceding the section extension field 1510.

As described above with reference to FIGS. 5 and 6, in order to transmit a signal to the UE 502, the first RU 204 of the base station 200 may perform SVD beamforming by using channel information associated with each antenna of the UE 502. In response to receiving the C-plane message 1500, the first RU 204 may start SVD processing based on the C-plane message 1500. For example, the first RU 204 may identify the number of channel information for each user based on the numUeID of the section extension field 1510, identify antenna-by-antenna channel information of the corresponding user based on the ueId of the section header 1508, and perform SRS-based channel estimation for each antenna of the UE 502 based on the SRS setup information of the section header 1508. Thereafter, the first RU 204 may perform SVD processing based on the antenna-by-antenna channel information. In an embodiment, at least some of the SRS-based channel estimation or SVD processing may be performed by the MMU 408 of the first RU 204.

The C-plane message of section type X (e.g., the C-plane message 1400 or the C-plane message 1500) may be transmitted to the first RU 204 at a period equal to or longer (greater) than a slot. For example, the C-plane message of section type X may be transmitted to the first RU 204 according to the SRS period. The transmission period of the C-plane message of section type X may be aligned with the SRS period. The C-plane message of section type X may be transmitted and/or received regardless of a transmission and/or reception window for the control plane (e.g., the windows 1104 and 1108 of FIG. 11). Thus, the C-plane message of section type X with section extension 17 may be transmitted to the first RU 204 at a period (or interval) of several milliseconds. Thus, the processing delay allowed for the first RU 204 to perform beamforming based on the information included in the C-plane message of section type X with section extension 17 may be several milliseconds. This may be in contrast to the processing delay for beamforming based on the C-plane message of section type 5 with section extension 17 being several hundred microseconds as described above with reference to FIG. 11. As a result, the first RU 204 may secure a longer time for SVD processing, and thus, the complexity of hardware implementation for SVD processing in the first RU 204 may be reduced by comparison.

In an embodiment, as described above with reference to Tables 2 to 4, the section extension field 1510 may be added for all ueId[2:0]. For example, in the C-plane message of section type X, each section header may include section extension 17 regardless of ueId [2:0] in the section header. Thus, for each user, the C-plane message of section type X may include as many section extension 17 fields as the number of ueIds of each user. Tables 8 to 10 below illustrate the ueId values of the section header and the numUeID values of the section extension 17 field in the section type X C-plane messages for user 0, user 1, and user 2, respectively. The ueId described in Tables 8 to 10 may indicate the value of ueID[4:0] of each user.

TABLE 8

| | ueId of section type X | numUeID of section |
|---|---|---|
| user 0 | C-plane message | extension 17 field |
| ueID = 01000b | ueID = 01000b | numUeID = 8 |
| ueID = 01001b | ueID = 01001b | numUeID = 8 |
| ueID = 01010b | ueID = 01010b | numUeID = 8 |
| ueID = 01011b | ueID = 01011b | numUeID = 8 |
| ueID = 01100b | ueID = 01100b | numUeID = 8 |
| ueID = 01101b | ueID = 01101b | numUeID = 8 |
| ueID = 01110b | ueID = 01110b | numUeID = 8 |
| ueID = 01111b | ueID = 01111b | numUeID = 8 |

Referring to Table 8, ueId[2:0] of user 0 may be any one of eight (8) values 000b to 111b. Each of the eight (8) ueId[2:0] values may correspond to any one of the antennas of user 0, and thus, the antennas of user 0 may be identified based on ueId[2:0] of user 0.Because the ueIDs in Table 8 are for user 0, the values of ueId[4:3] may be equal to each other. In Table 8, regardless of the values of ueId[2:0], section extension 17 may follow the section header for each ueId. Because user 0 has eight (8) ueIds, section extension 17 for each section header may include numUeID with a value of eight (8).

TABLE 9

| | ueId of section type X | numUeID of section |
|---|---|---|
| user 1 | C-plane message | extension 17 field |
| ueID = 10000b | ueID = 10000b | numUeID = 4 |
| ueID = 10001b | ueID = 10001b | numUeID = 4 |
| ueID = 10010b | ueID = 10010b | numUeID = 4 |
| ueID = 10011b | ueID = 10011b | numUeID = 4 |

Referring to Table 9, ueId[2:0] of user 1 may be any one of four (4) values 000b to 011b. Each of the four (4) ueId[2:0] values may correspond to any one of the antennas of user 1, and thus, the antennas of user 1 may be identified based on ueId[2:0] of user 1. Because the ueIDs in Table 9 are for user 1, the values of ueId[4:3] may be equal to each other. In Table 9, regardless of the values of ueId[2:0], section extension 17 may follow the section header for each ueId. Because user 1 has four (4) ueIds, section extension 17 for each section header may include numUeID with a value of four (4).

TABLE 10

| | ueId of section type X | numUeID of section |
|---|---|---|
| user 2 | C-plane message | extension 17 field |
| ueID = 11000b | ueID = 11000b | numUeID = 2 |
| ueID = 11001b | ueID = 11001b | numUeID = 2 |

Referring to Table 10, ueId[2:0] of user 2 may be 000b or 001b. Each of the two (2) ueId[2:0] values may correspond to any one of the antennas of user 2, and thus, the antennas of user 2 may be identified based on ueId[2:0] of user 2. Because the ueIDs in Table 10 are for user 2, the values of ueId[4:3] may be equal to each other. In Table 10, regardless of the values of ueId[2:0], section extension 17 may follow the section header for each ueId. Because user 2 has two (2) ueIds, section extension 17 for each section header may include numUeID with a value of two (2).

In an embodiment, the section extension field 1510 may be added only for one or more particular ueId[2:0]. Based on the ueId[2:0] value included in the section header of each section type X C-plane message, section extension 17 may be added only for some section headers of section types X. For example, in the C-plane message of section type X, section extension 17 may be added only for a section header (section headers) whose ueId[2:0] value is one or more particular values. For example, section extension 17 may be added only for a section header with ueId[2:0] =0. Additionally or alternatively, section extension 17 may be added only for a section header (section headers) where the value of ueId[2:0] is an even number, a section header (section headers) where the value of ueId[2:0] is an odd number, a section header (section headers) where the value of ueId[2:0] is a multiple of a particular natural number, a section header (section headers) where the value of ueId[2:0] is a prime number, and/or a value equal to numUeID divided by 2 (or rounded off/rounded up below the decimal point/truncated below the decimal point). However, the present disclosure is not limited thereto. Tables 11 to 13 below illustrate the ueId values of the section header and the numUeID values of the section extension 17 field in the section type X C-plane messages for user 0, user 1, and user 2, respectively. The ueId described in Tables 11 to 13 may indicate the value of ueID [4:0] of each user.

TABLE 11

| | ueId of section type X | numUeID of section |
|---|---|---|
| user 0 | C-plane message | extension 17 field |
| ueID = 01000b | ueID = 01000b | numUeID = 8 |
| ueID = 01001b | ueID = 01001b | — |
| ueID = 01010b | ueID = 01010b | — |
| ueID = 01011b | ueID = 01011b | — |
| ueID = 01100b | ueID = 01100b | — |
| ueID = 01101b | ueID = 01101b | — |
| ueID = 01110b | ueID = 01110b | — |
| ueID = 01111b | ueID = 01111b | — |

Referring to Table 11, ueId[2:0] of user 0 may be any one of eight (8) values 000b to 111b. In contrast to Table 8, in Table 11, section extension 17 may follow only the section header of section type X including ueId[2:0] =0 (e.g., ueId=01000b). Section extension 17 may not be added for the other section headers of section type X associated with user 0.

TABLE 12

| | ueId of section type X | numUeID of section |
|---|---|---|
| user 1 | C-plane message | extension 17 field |
| ueID = 10000b | ueID = 10000b | numUeID = 4 |
| ueID = 10001b | ueID = 10001b | — |
| ueID = 10010b | ueID = 10010b | — |
| ueID = 10011b | ueID = 10011b | — |

Referring to Table 12, ueId[2:0] of user 1 may be any one of four (4) values 000b to 011b. In contrast to Table 9, in Table 12, section extension 17 may follow only the section header of section type X including ueId[2:0]=0 (e.g., ueId=10000b). Section extension 17 may not be added for the other section headers of section type X associated with user 1.

TABLE 13

| | ueId of section type X | numUeID of section |
|---|---|---|
| user 2 | C-plane message | extension 17 field |
| ueID = 11000b | ueID = 11000b | numUeID = 2 |
| ueID = 11001b | ueID = 11001b | — |

Referring to Table 13, ueId[2:0] of user 2 may be any one of values 000b or 001b. In contrast to Table 10, in Table 13, section extension 17 may follow only the section header of section type X including ueId[2:0]=0 (e.g., ueId=01000b). Section extension 17 may not be added for the other section headers of section type X associated with user 2.

An embodiment in which section extension 17 is added to the C-plane message of section type 6 or section type X has been described with reference to FIGS. 13 and 15. However, the present disclosure is not limited thereto. In an embodiment, section extension 17 may be added to a C-plane message including a field indicating ueId among not only section type 6 or section type X but also non-delay-managed C-plane messages (e.g., C-plane messages that do not need to be transmitted per slot or C-plane messages that are transmitted and/or received regardless of the C-plane transmission and/or reception window). Prior to, simultaneously with, or subsequently to the C-plane message, the first RU 204 may obtain channel information for each antenna of the terminal based on the C-plane message of section type 6 or the C-plane message of section type X and perform SVD-based beamforming based on the C-plane message and channel information described above.

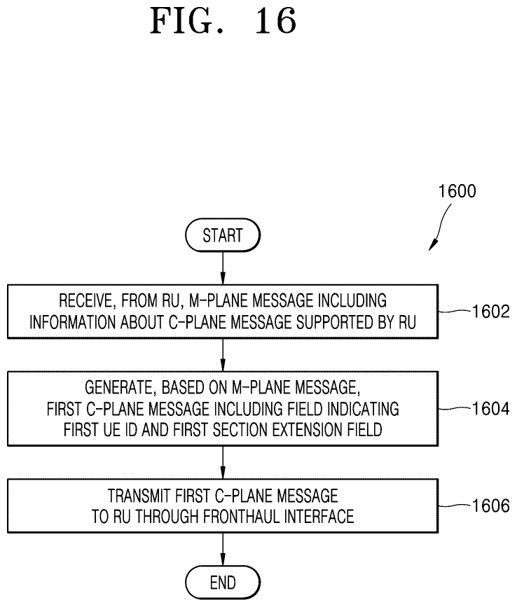

FIG. 16 illustrates a flowchart of a method for wireless communication performed by a DU, according to an embodiment of the present disclosure.

Referring to FIG. 16, a method 1600 performed by the DU 202 may include operations 1602, 1604, and 1606. However, the present disclosure is not limited thereto, and operations 1602 to 1606 may be individually or collectively performed by any electronic device. The method 1600, according to an embodiment of the present disclosure, is not limited to FIG. 16, and any of the operations illustrated in FIG. 16 may be omitted or operations not illustrated in FIG. 16 may be further included. In some embodiments, the order of at least some of operations 1602, 1604, and 1606 may be modified.

In operation 1602, the DU 202 may receive, from the first RU 204, an M-plane message including information about a C-plane message supported by the first RU 204. In operation 1604, based on the M-plane message, the DU 202 may generate a first C-plane message including a field indicating a first UE ID and a first section extension field. The first section extension field may include a parameter indicating the number of UE IDs of the user associated with the first UE ID. In operation 1606, the DU 202 may transmit the first C-plane message to the first RU 204 through the fronthaul interface.

Additionally or alternatively, the first C-plane message may be a message that is transmitted regardless of the transmission and/or reception window for the control plane. The first C-plane message may not be a message that is transmitted on a symbol-by-symbol or slot-by-slot basis. The transmission period of the first C-plane message may be longer (greater) than the transmission period of the symbol or the transmission period of the slot. The first C-plane message may be transmitted at a period equal to or longer (greater) than the transmission period of the slot. The first C-plane message may be transmitted according to the SRS period (e.g., at the same period as the SRS transmission period).

Additionally or alternatively, the M-plane message may indicate that the first RU 204 supports a C-plane message including a first section extension field together with any one of UE-specific channel information or information for requesting a channel estimation operation to the first RU 204. For example, the M-plane message may indicate that the first RU 204 supports a C-plane message of section extension 6 including a section extension 17 field (e.g., the C-plane message 1300 of FIG. 13). The M-plane message may indicate that the first RU 204 supports a C-plane message of section extension X including a section extension 17 field (e.g., the C-plane message 1500 of FIG. 15).

Additionally or alternatively, the first C-plane message may further include a field indicating channel information corresponding to the first UE ID. For example, the first C-plane message may include a field indicating a particular ueId and a field indicating channel information corresponding to a particular ueId.

Additionally or alternatively, the first C-plane message may further include a channel estimation operation command to the first RU 204. For example, the first C-plane message may include information for commanding (or instructing or requesting) the first RU 204 to perform channel estimation. The first C-plane message may include information necessary to perform channel estimation. For example, the first C-plane message may include SRS information to support SRS-based channel estimation.

Additionally or alternatively, the method 1600 may include transmitting, to the first RU 204 through the fronthaul interface, a second C-plane message including a second UE ID of the user of the first UE ID and a second section extension field. The second section extension field may include a parameter indicating the number of UE IDs corresponding to the user associated with the first UE ID. For example, the first UE ID and the second UE ID may be associated with the same user, and thus, the second section extension field may have the same value as the first section extension field.

Additionally or alternatively, the method 1600 may include an operation of transmitting, to the first RU 204 through the fronthaul interface, a second C-plane message including a second UE ID of the user associated with the first UE ID. The field of the first C-plane message indicating the first UE ID may include least significant bits (LSBs) including three consecutive 0s. For example, the first C-plane message may include a ueId field with ueId[2:0]=0. The second C-plane message may not include a section extension field including a parameter indicating the number of UE IDs.

In an embodiment, when individually or collectively executed by the processor 302, one or more instructions stored in the memory 304 of the DU 202 may cause the DU 202 to perform any combination of the operations of the DU 202 described above.

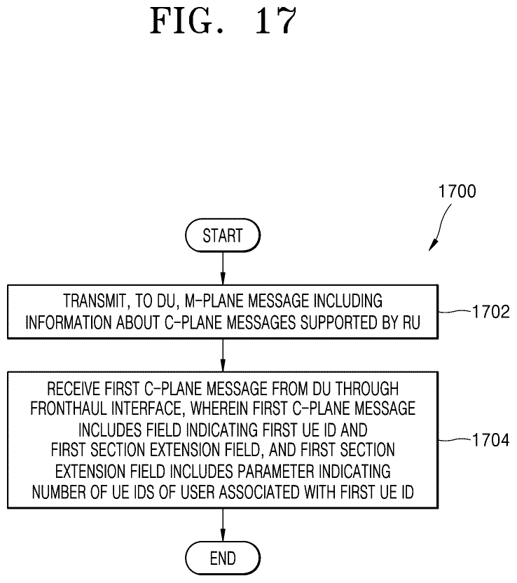

FIG. 17 illustrates a flowchart of a method for wireless communication performed by an RU, according to an embodiment of the present disclosure.

Referring to FIG. 17, a method 1700 performed by the first RU 204 may include operations 1702 and 1704. However, the present disclosure is not limited thereto, and operations 1702 and 1704 may be individually or collectively performed by any electronic device. The method 1700, according to an embodiment of the present disclosure, is not limited to that illustrated in FIG. 17, and any of the operations illustrated in FIG. 17 may be omitted or operations not illustrated in FIG. 17 may be further included. In some embodiments, the order of at least some of operations 1702 and 1704 may be modified.

In operation 1702, the first RU 204 may transmit, to the DU 202, an M-plane message including information about a C-plane message supported by the first RU 204. In operation 1704, the first RU 204 may receive a first C-plane message from the DU 202 through the fronthaul interface. The first C-plane message may include a field indicating a first UE ID and a first section extension field. The first section extension field may include a parameter indicating the number of UE IDs of the user associated with the first UE ID.

Additionally or alternatively, the method 1700 may further include an operation of performing SVD processing based on the first C-plane message. For example, the first RU 204 may further perform at least some of operations 710 and 712 of FIG. 7 based on the first C-plane message. In an embodiment, the first RU 204 may estimate one or more characteristics of a channel for each antenna of the terminal based on the UE ID indicated by the first C-plane message and the number of UE IDs of the corresponding user and perform SVD processing based on the estimation result.

Additionally or alternatively, the first C-plane message may be a message that is transmitted regardless of the reception window for the control plane. The first C-plane message may not be a message that is transmitted on a symbol-by-symbol basis. The transmission period of the first C-plane message may be longer than the transmission period of the symbol. The first C-plane message may be transmitted at a period equal to or longer than the transmission period of the slot. The first C-plane message may be transmitted according to the SRS period (e.g., at the same period as the SRS transmission period).

Additionally or alternatively, the M-plane message may indicate that the first RU 204 supports a C-plane message including a first section extension field together with any one of UE-specific channel information or information for requesting a channel estimation operation to the first RU 204. For example, the M-plane message may indicate that the first RU 204 supports a C-plane message of section extension 6 including a section extension 17 field (e.g., the C-plane message 1300 of FIG. 14). The M-plane message may indicate that the first RU 204 supports a C-plane message of section extension X including a section extension 17 field (e.g., the C-plane message 1500 of FIG. 15).

Additionally or alternatively, the first C-plane message may further include a field indicating channel information corresponding to the first UE ID. For example, the first C-plane message may include a field indicating a particular ueId and a field indicating channel information corresponding to a particular ueId.

Additionally or alternatively, the first C-plane message may further include a channel estimation operation command to the first RU 204. For example, the first C-plane message may include information for commanding (or instructing or requesting) the first RU 204 to perform channel estimation. The first C-plane message may include information necessary to perform channel estimation. For example, the first C-plane message may include SRS information to support SRS-based channel estimation. In response to the first C-plane message, the first RU 204 may perform channel estimation.

Additionally or alternatively, the method 1700 may include an operation of receiving, from the DU 202 through the fronthaul interface, a second C-plane message including a second UE ID of the user of the first UE ID and a second section extension field. The second section extension field may include a parameter indicating the number of UE IDs corresponding to the user associated with the first UE ID. For example, the first UE ID and the second UE ID may be associated with the same user, and thus, the second section extension field may have the same value as the first section extension field.

Additionally or alternatively, the method 1700 may include an operation of receiving, from the DU 202 through the fronthaul interface, a second C-plane message including a second UE ID of the user associated with the first UE ID. The field of the first C-plane message indicating the first UE ID may include least significant bits (LSBs) including three consecutive 0s. For example, the first C-plane message may include a ueId field with ueId [2:0]=0. The second C-plane message may not include a section extension field including a parameter indicating the number of UE IDs.

In an embodiment, when individually or collectively executed by the processor 402, one or more instructions stored in the memory 404 of the first RU 204 may cause the first RU 204 to perform any combination of the operations of the first RU 204 described above.

At least some of the methods, according to an embodiment of the present disclosure, may be embodied in the form of program commands executable through various computer means, which may be recorded on a computer-readable recording medium. The computer-readable recording medium may include program commands, data files, and data structures either alone or in combination. The program commands recorded on the computer-readable recording medium may be those that are especially designed and configured for the present disclosure, or may be those that are known and available to those of ordinary skill in computer software. Examples of the computer-readable recording medium include, but are not limited to, magnetic media (e.g., hard disks, floppy disks, or magnetic tapes), optical media (e.g., compact disc read-only memories (CD-ROMs) or digital versatile discs (DVDs)), and magneto-optical media (e.g., floptical disks), and hardware devices (e.g., read-only memories (ROMs), random access memories (RAMs), or flash memories) specially configured to store and execute program commands. Examples of the program commands include machine language codes that may be generated by a compiler, and high-level language codes that may be executed by a computer by using an interpreter.

The machine-readable storage medium may be provided in the form of a non-transitory storage medium. Here, the term “non-transitory storage medium” may indicate that the storage medium is a tangible device and does not include signals (e.g., electromagnetic waves), and may indicate that data may be semi-permanently or temporarily stored in the storage medium. For example, the “non-transitory storage medium” may include a buffer in which data is temporarily stored.

According to an embodiment of the present disclosure, the method, according to various embodiments of the present disclosure, described herein may be included and provided in a computer program product. The computer program product may be traded as a product between a seller and a buyer. The computer program product may be distributed in the form of a machine-readable storage medium (e.g., a CD-ROM) or may be distributed (e.g., downloaded or uploaded) online through an application store or directly between two user devices (e.g., smartphones). In the case of online distribution, at least a portion of the computer program product (e.g., a downloadable app) may be at least temporarily stored or temporarily generated in a machine-readable storage medium such as a memory of a manufacturer server, a memory of an application store server, or a memory of a relay server.

While certain embodiments of the present disclosure have been described above with reference to the drawings, those of ordinary skill in the art may make various changes and modifications therein from the above description. For example, suitable results may be achieved even when the described technologies are performed in a different order from the described method and/or the components of the described computer system or module are coupled or combined in a different form from the described method or are replaced or substituted by other components or equivalents.

What is claimed is:

1. A method for wireless communication performed by a distributed unit (DU), the method comprising:
receiving, from a radio unit (RU), a management-plane message comprising information about a control-plane message supported by the RU;
generating, based on the management-plane message, a first control-plane message comprising a field indicating a first user equipment identifier (UE ID) and a first section extension field; and
transmitting, to the RU through a fronthaul interface, the first control-plane message during a time period longer than a slot,
wherein the first section extension field comprises a parameter indicating a number of UE IDs of a user associated with the first UE ID.

2. The method of claim 1, wherein the transmitting of the first control-plane message comprises:
transmitting, to the RU through the fronthaul interface, the first control-plane message during the time period longer than the slot, regardless of a transmission window for a control plane.

3. The method of claim 1, wherein the management-plane message indicates that the RU supports the control-plane message comprising the first section extension field and at least one of UE-specific channel information or information requesting a channel estimation operation to the RU.

4. The method of claim 1, wherein the first control-plane message further comprises a field indicating channel information corresponding to the first UE ID.

5. The method of claim 1, wherein the first control-plane message further comprises a channel estimation operation command to the RU.

6. The method of claim 1, further comprising:
transmitting, to the RU through the fronthaul interface, a second control-plane message comprising a second UE ID of the user associated with the first UE ID and a second section extension field,
wherein the second section extension field comprises a parameter indicating a number of UE IDs corresponding to the user.

7. The method of claim 1, further comprising:
transmitting, to the RU through the fronthaul interface, a second control-plane message comprising a second UE ID of the user associated with the first UE ID,
wherein the field indicating the first UE ID comprises least significant bits (LSBs) comprising three consecutive zeros.

8. A method for wireless communication performed by a radio unit (RU), the method comprising:
transmitting, to a distributed unit (DU), a management-plane message comprising information about a control-plane message supported by the RU; and
receiving, from the DU through a fronthaul interface, a first control-plane message during a time period longer than a slot,
wherein the first control-plane message comprises a field indicating a first user equipment identifier (UE ID) and a first section extension field, and
wherein the first section extension field comprises a parameter indicating a number of UE IDs of a user associated with the first UE ID.

9. The method of claim 8, further comprising:
performing singular value decomposition (SVD), based on the first control-plane message.

10. The method of claim 8, wherein the receiving of the first control-plane message comprises:
receiving, from the DU through the fronthaul interface, the first control-plane message regardless of a reception window for a control plane.

11. The method of claim 8, wherein the management-plane message indicates that the RU supports the control-plane message comprising the first section extension field and at least one of UE-specific channel information or information requesting a channel estimation operation to the RU.

12. The method of claim 8, wherein the first control-plane message further comprises a field indicating channel information corresponding to the first UE ID.

13. The method of claim 8, wherein the first control-plane message further comprises a channel estimation operation command to the RU.

14. The method of claim 8, further comprising receiving, from the DU through the fronthaul interface, a second control-plane message comprising a second UE ID of the user associated with the first UE ID and a second section extension field,
wherein the second section extension field comprises a parameter indicating a number of UE IDs corresponding to the user.

15. The method of claim 8, further comprising receiving, from the DU through the fronthaul interface, a second control-plane message comprising a second UE ID of the user associated with the first UE ID,
wherein the field indicating the first UE ID comprises least significant bits (LSBs) comprising three consecutive zeros.

16. A distributed unit (DU) device for wireless communication, the DU device comprising:
one or more processors comprising processing circuitry; and
memory storing instructions,
wherein the instructions, when executed by the one or more processors individually or collectively, cause the DU device to:
receive, from a radio unit (RU), a management-plane message comprising information about a control-plane message supported by the RU;
generate, based on the management-plane message, a first control-plane message comprising a field indicating a first user equipment identifier (UE ID) and a first section extension field; and
transmit, to the RU through a fronthaul interface, the first control-plane message during a time period longer than a slot,
wherein the first section extension field comprises a parameter indicating a number of UE IDs of a user associated with the first UE ID.

17. The DU device of claim 16, wherein the instructions, when executed by the one or more processors individually or collectively, further cause the DU device to:
transmit, to the RU through the fronthaul interface, the first control-plane message during the time period longer than the slot, regardless of a transmission window for a control plane.

18. The DU device of claim 16, wherein the management-plane message indicates that the RU supports the control-plane message comprising the first section extension field and at least one of UE-specific channel information or information requesting a channel estimation operation to the RU.

19. The DU device of claim 16, wherein the instructions, when executed by the one or more processors individually or collectively, further cause the DU device to:
transmit, to the RU through the fronthaul interface, a second control-plane message comprising a second UE ID of the user associated with the first UE ID and a second section extension field,
wherein the second section extension field comprises a parameter indicating a number of UE IDs corresponding to the user.

20. The DU device of claim 16, wherein the instructions, when executed by the one or more processors individually or collectively, further cause the DU device to:
transmit, to the RU through the fronthaul interface, a second control-plane message comprising a second UE ID of the user associated with the first UE ID,
wherein the field indicating the first UE ID comprises least significant bits (LSBs) comprising three consecutive zeros.
